(19) United States
(12) Patent Application Publication
(10) Pub. No.: US 2025/0276515 A1
(43) Pub. Date: Sep. 4, 2025

(54) LIQUID JETTING APPARATUS AND CONTROL METHOD OF LIQUID JETTING APPARATUS

(71) Applicant: SEIKO EPSON CORPORATION, Tokyo (JP)

(72) Inventors: Akira MIYAGISHI, SHIOJIRI-SHI (JP); Hiroaki OKUI, AZUMINO-SHI (JP); Nobuaki ITO, SUWA-SHI (JP)

(21) Appl. No.: 19/069,418

(22) Filed: Mar. 4, 2025

(30) Foreign Application Priority Data
Mar. 4, 2024 (JP) 2024-031829

(51) Int. Cl. B41J 2/045; B41J 2/17

(52) U.S. Cl. CPC B41J 2/04541; B41J 2/0457; B41J 2/04573; B41J 2/04581; B41J 2/04588; B41J 2/04596; B41J 2/1707

(57) ABSTRACT

An evaluation control portion, in which the evaluation control portion causes the detection circuit to detect, as first residual vibration, residual vibration caused by continuously performing jetting driving in which the piezoelectric element is driven with a vibration pulse for generating, at the vibration plate, vibration larger than vibration of the vibration plate caused by non-jetting driving in which the piezoelectric element is driven with a minute vibration pulse for not jetting an ink from the nozzle, causes the detection circuit to detect, as second residual vibration, residual vibration caused by continuously driving the piezoelectric element in order of the non-jetting driving and the jetting driving, and evaluates a variation in a jetting characteristic of the nozzle between a case where the jetting driving is continuous and a case where the jetting driving is not continuous based on the first residual vibration and the second residual vibration.

The present application is based on, and claims priority from JP Application Serial Number 2024-031829, filed Mar. 4, 2024, the disclosure of which is hereby incorporated by reference herein in its entirety.

### BACKGROUND

### 1. Technical Field

The present disclosure relates to a liquid jetting apparatus and a control method of a liquid jetting apparatus.

### 2. Related Art

A liquid jetting apparatus that prints an image by causing a nozzle to jet a liquid such as an ink using a piezoelectric element is known. For example, the liquid jetting apparatus includes a liquid jetting head that jets the liquid filling a pressure chamber from the nozzle by causing the piezoelectric element to vibrate a vibration plate that constitutes a part of the pressure chamber. In this type of liquid jetting apparatus, it is known that a change in viscosity of the liquid affects jetting characteristics of the liquid from the nozzle. For this reason, for example, JP-A-2013-163290 discloses a liquid ejecting apparatus including a control unit that supplies a minute vibration drive signal for generating minute vibration of a liquid in a pressure generating chamber without jetting the liquid from a nozzle opening to a pressure generating unit.

Depending on a printed image, continuous jetting in which an ink is continuously jetted to a plurality of pixels and single jetting in which the ink is jetted to only one pixel among the plurality of pixels may be mixed in some cases. In the continuous jetting, jetting driving in which the piezoelectric element is driven with a drive signal including a jetting waveform for jetting the liquid from the nozzle is continuously performed. On the other hand, in the single jetting, the jetting driving described above is not continuous. For this reason, the jetting characteristics of the nozzle vary between the continuous jetting and the single jetting.

As described above, it is known that thickening of the liquid is suppressed by performing non-jetting driving in which the piezoelectric element is driven with a drive signal including a minute vibration waveform for not jetting the liquid from the nozzle. Therefore, for example, even in the single jetting, in order to suppress the thickening of the liquid, performing the non-jetting driving instead of the jetting driving in a period when the jetting driving is not performed is considered. In this aspect, variations in the jetting characteristics between the continuous jetting and the single jetting can be reduced by adjusting the minute vibration waveform.

Herein, for example, a business model in which a head manufacturer that manufactures the liquid jetting head sells the liquid jetting head to a printing apparatus manufacturer, and the printing apparatus manufacturer assembles the liquid jetting apparatus is considered. In the business model, in many cases, usage conditions of the liquid jetting head such as ink conditions are determined by the printing apparatus manufacturer, not the head manufacturer. When the head manufacturer assembles the liquid jetting apparatus, the head manufacturer also determines the usage conditions and thus can appropriately evaluate the variations in the jetting characteristics described above. On the other hand, in the business model described above, there is a possibility in which the head manufacturer cannot appropriately evaluate the variations in the jetting characteristics in a stage where the head manufacturer manufactures and sells the liquid jetting head. In this case, it is difficult for the head manufacturer to determine an appropriate minute vibration waveform for reducing the variations in the jetting characteristics. For this reason, in the business model described above, the printing apparatus manufacturer needs to appropriately evaluate the variations in the jetting characteristics and to appropriately determine the minute vibration waveform for reducing the variations in the jetting characteristics, and there is a possibility in which this may cause an excessive load on the printing apparatus manufacturer. For this reason, in the business model described above, it is desired that the evaluation of the variations in the jetting characteristics and the determination of the appropriate minute vibration waveform for reducing the variations in the jetting characteristics can be appropriately and easily performed. In particular, it is desired that the variations in the jetting characteristics can be appropriately and easily evaluated. The problems described above are desired to be relatively small even when the manufacturer that manufactures the liquid jetting apparatus and the manufacturer that manufactures the liquid jetting head have the same business model. For example, it is also considered that a user uniquely sets usage conditions different from the usage conditions assumed in advance by the manufacturer of the liquid jetting head or the liquid jetting apparatus, and in this case, the same problems occur.

### SUMMARY

According to an aspect of the present disclosure, in order to solve the problems described above, there is provided a liquid jetting apparatus including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element and a control portion, in which the control portion is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causes the detection portion to detect, as first residual vibration, the residual vibration caused by continuously performing the vibration driving, causes the detection portion to detect, as second residual vibration, the residual vibration caused by continuously driving the piezoelectric element in order of the minute vibration driving and the vibration driving, and evaluates a variation in a jetting characteristic of the nozzle between a case where the vibration driving is continuous and a case where the vibration driving is not continuous based on the first residual vibration and the second residual vibration detected by the detection portion.

In addition, according to another aspect of the present disclosure, there is provided a liquid jetting apparatus including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element and a control portion, in which the control portion is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causes the detection portion to detect, as first residual vibration, the residual vibration caused by continuously performing the vibration driving, causes the detection portion to detect, as second residual vibration, the residual vibration caused by continuously driving the piezoelectric element in order of the minute vibration driving and the vibration driving, and determines a waveform of the minute vibration pulse based on the first residual vibration and the second residual vibration detected by the detection portion.

In addition, according to still another aspect of the present disclosure, there is provided a control method of a liquid jetting apparatus including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element, the control method including performing minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causing the detection portion to detect, as first residual vibration, the residual vibration caused by continuously performing the vibration driving, causing the detection portion to detect, as second residual vibration, the residual vibration caused by continuously driving the piezoelectric element in order of the minute vibration driving and the vibration driving, and evaluating a variation in a jetting characteristic of the nozzle between a case where the vibration driving is continuous and a case where the vibration driving is not continuous based on the first residual vibration and the second residual vibration detected by the detection portion.

### BRIEF DESCRIPTION OF THE DRAWINGS

FIG. 1 is a block diagram illustrating an example of a configuration of a liquid jetting apparatus according to an embodiment of the present disclosure.

FIG. 2 is a configuration diagram schematically illustrating the liquid jetting apparatus.

FIG. 3 is an exploded perspective view of a liquid jetting head.

FIG. 4 is a sectional view taken along line IV-IV illustrated in FIG. 3.

FIG. 5 is a block diagram illustrating an example of a configuration of the liquid jetting head.

FIG. 6 is a timing chart illustrating an example of an operation of the liquid jetting apparatus in a unit period.

FIG. 7 is a graph illustrating an example of a waveform of a residual vibration signal.

FIG. 8 is an explanatory diagram for describing an example of a drive signal used in evaluating variations in jetting characteristics of a nozzle.

FIG. 9 is a flowchart illustrating an example of an operation of the liquid jetting apparatus when evaluating the variations in the jetting characteristics of the nozzle.

FIG. 10 is a flowchart illustrating an example of a comparison process of residual vibration illustrated in FIG. 9.

FIG. 11 is a block diagram illustrating an example of a configuration of a liquid jetting head according to a third modification example.

FIG. 12 is a timing chart illustrating an example of an operation of a liquid jetting apparatus according to the third modification example.

### DESCRIPTION OF EMBODIMENTS

Hereinafter, an embodiment for carrying out the present disclosure will be described with reference to the drawings. Meanwhile, in each drawing, the dimensions and scale of each portion are different from the actual dimensions and scale as appropriate. In addition, the embodiment described below are preferred specific examples of the present disclosure and are thus added with various technically preferred limitations, but the scope of the present disclosure is not limited to such an embodiment unless description for limiting the present disclosure is particularly made in the following description.

### 1. Embodiment

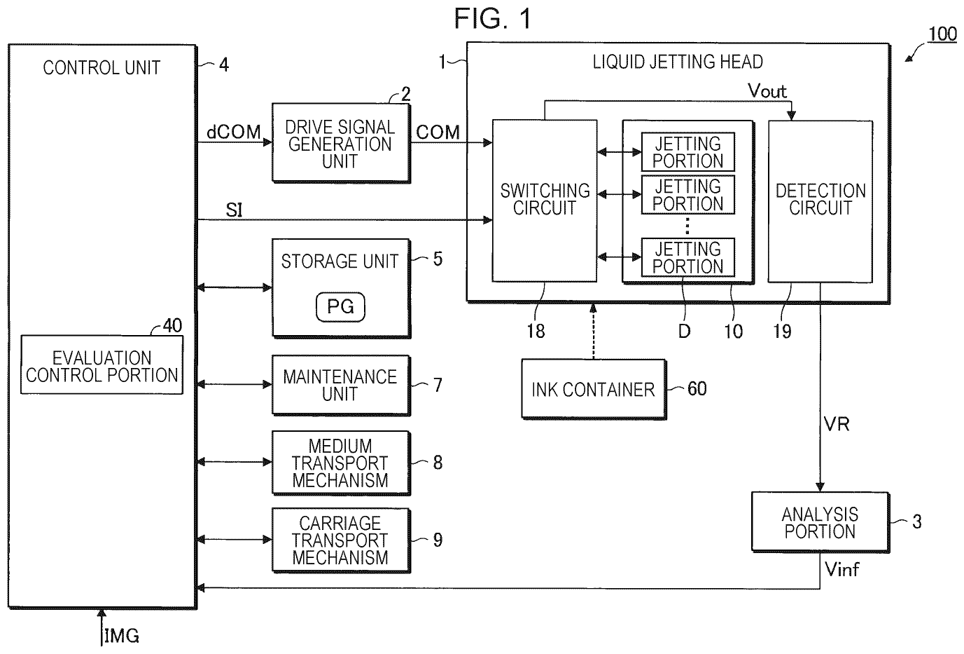

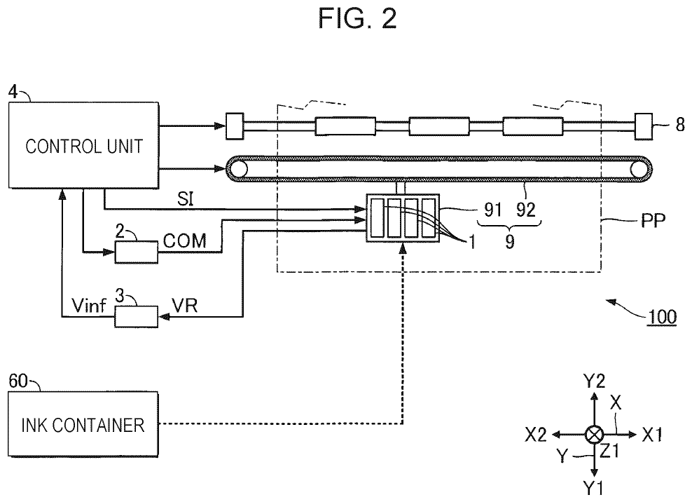

First, an outline of a liquid jetting apparatus 100 according to the present embodiment will be described with reference to FIG. 1. In the present embodiment, a case where the liquid jetting apparatus 100 is an ink jet printer that jets an ink to a medium PP to form an image is assumed as an example. In the present embodiment, recording paper illustrated in FIG. 2 to be described later is assumed as the medium PP. The ink is an example of a “liquid”.

FIG. 1 is a block diagram illustrating an example of a configuration of the liquid jetting apparatus 100 according to the embodiment of the present disclosure.

For example, print data IMG indicating an image to be formed by the liquid jetting apparatus 100 is supplied to the liquid jetting apparatus 100 from a host computer such as a personal computer and a digital camera. The liquid jetting apparatus 100 performs a printing process of forming the image indicated by the print data IMG supplied from the host computer on the medium PP.

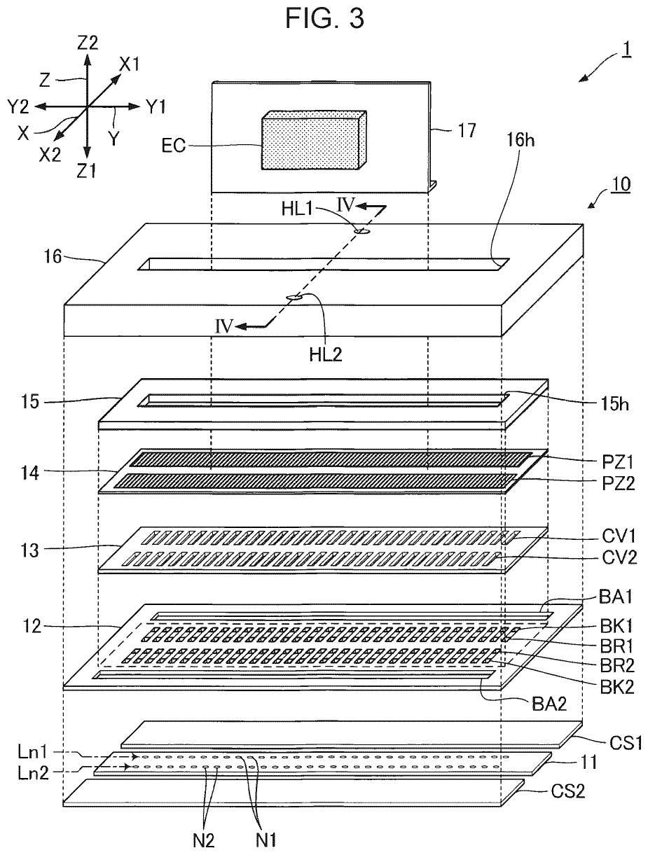

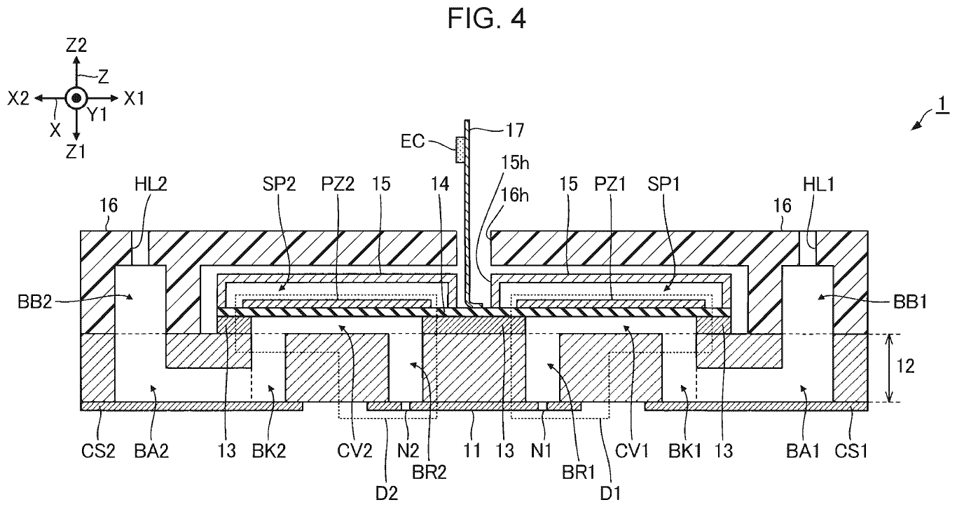

The liquid jetting apparatus 100 has a liquid jetting head 1 that is provided with a jetting portion D including a nozzle N which jets an ink, a drive signal generation unit 2 that generates a plurality of drive signals COM for driving the jetting portion D, and an analysis portion 3 that analyzes residual vibration to be described later. The nozzle N will be described later with reference to FIGS. 3 and 4. In addition, the liquid jetting apparatus 100 has a control unit 4 that controls each portion of the liquid jetting apparatus 100 and a storage unit 5 that stores various types of information such as the print data IMG and a control program PG of the liquid jetting apparatus 100. Further, the liquid jetting apparatus 100 includes a maintenance unit 7 that performs a maintenance process of the liquid jetting head 1, a medium transport mechanism 8 that transports the medium PP, a carriage transport mechanism 9 that reciprocates a carriage 91, and an ink container 60 that stores the ink. The carriage 91 will be described later with reference to FIG. 2.

In the present embodiment, a case where the liquid jetting head 1 corresponds to the drive signal generation unit 2, and the liquid jetting head 1 corresponds to the analysis portion 3 is assumed. For example, the liquid jetting apparatus 100 may have a plurality of liquid jetting heads 1, a plurality of drive signal generation units 2, and a plurality of analysis portions 3. In this case, for example, the plurality of drive signal generation units 2 correspond to the plurality of liquid jetting heads 1 on a one-to-one basis, and the plurality of analysis portions 3 correspond to the plurality of liquid jetting heads 1 on a one-to-one basis. Alternatively, the liquid jetting apparatus 100 may have one liquid jetting head 1, one drive signal generation unit 2 corresponding to the liquid jetting head 1, and one analysis portion 3 corresponding to the liquid jetting head 1.

In the present embodiment, a case where the liquid jetting apparatus 100 has four liquid jetting heads 1 corresponding to four types of inks of cyan, magenta, yellow, and black, respectively is assumed. That is, in the present embodiment, a case where the liquid jetting apparatus 100 has the four liquid jetting heads 1, the four drive signal generation units 2, and the four analysis portions 3 is assumed. However, hereinafter, for convenience of description, as illustrated in FIG. 1, one liquid jetting head 1 of the four liquid jetting heads 1 and one drive signal generation unit 2 corresponding to the one liquid jetting head 1 will be focused on and described in some cases.

First, the control unit 4, the drive signal generation unit 2, and the storage unit 5 will be described before the liquid jetting head 1 is to be described.

The control unit 4 is configured to include one or a plurality of central processing units (CPU). The control unit 4 may be configured to include a programmable logic device such as a field-programmable gate array (FPGA), instead of the CPU or in addition to the CPU. In addition, for example, the control unit 4 generates a signal for controlling an operation of each portion of the liquid jetting apparatus 100, such as a print signal SI and a waveform designation signal dCOM, by operating in accordance with the control program PG stored in the storage unit 5.

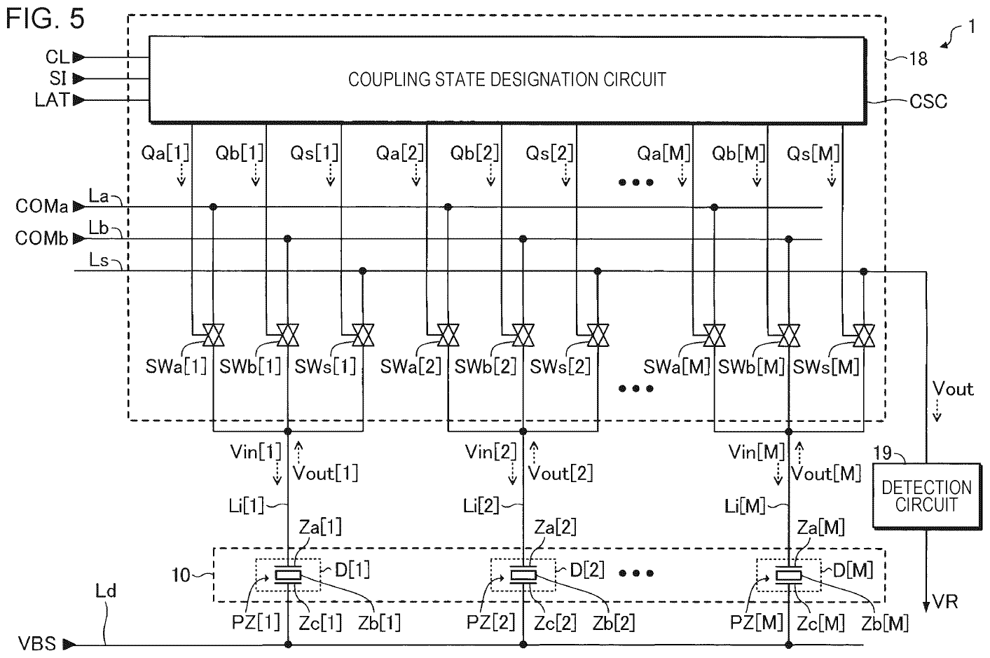

Herein, the waveform designation signal dCOM is a digital signal that defines each of waveforms of the plurality of drive signals COM. In addition, each drive signal COM is an analog signal for driving the jetting portion D. In the present embodiment, as illustrated in FIG. 5 and the like to be described later, a case where the plurality of drive signals COM include drive signals COMa and COMb is assumed. In addition, the print signal SI is a digital signal for designating a type of operation of the jetting portion D. Specifically, the print signal SI is a signal for designating the type of operation of the jetting portion D by designating whether or not to supply each drive signal COM to the jetting portion D.

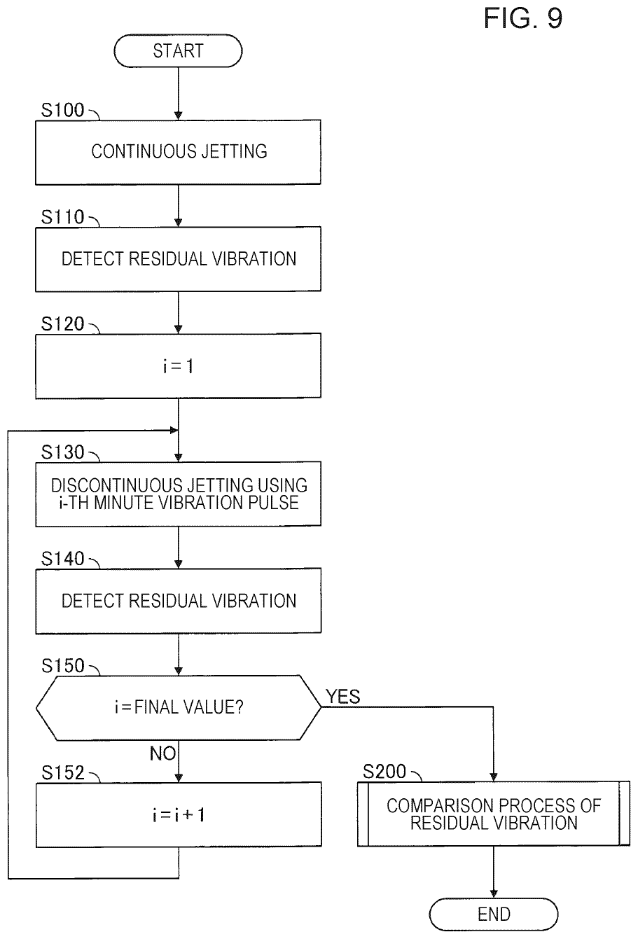

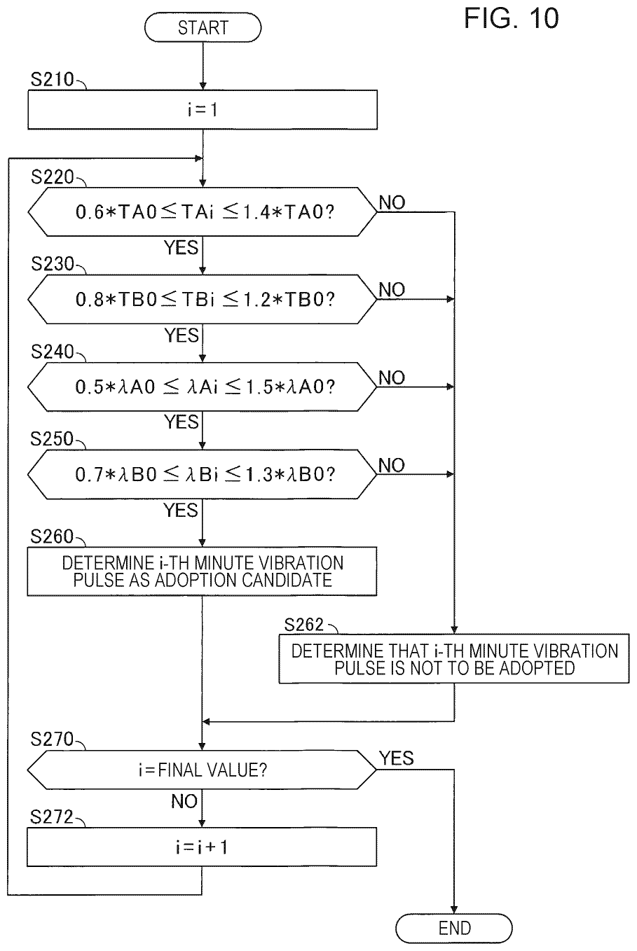

In addition, in the present embodiment, the control unit 4 functions as an evaluation control portion 40 by operating in accordance with the control program PG stored in the storage unit 5. The control program PG may be provided from, for example, a head manufacturer that manufactures the liquid jetting head 1. Details of an operation of the evaluation control portion 40 will be described with reference to FIGS. 9 and 10. For example, the evaluation control portion 40 evaluates variations in jetting characteristics of the nozzle N based on residual vibration analyzed by the analysis portion 3. The jetting characteristics of the nozzle N are, for example, jetting characteristics of an ink from the jetting portion D. For example, the variations in the jetting characteristics evaluated by the evaluation control portion 40 are variations in jetting characteristics between continuous jetting in which jetting driving of driving the jetting portion D with the drive signal COM for jetting an ink from the nozzle N is continuous and discontinuous jetting in which the jetting driving is not continuous. The evaluation control portion 40 is an example of a “control portion”.

The drive signal generation unit 2 includes, for example, a digital analog converter (DAC) and generates the plurality of drive signals COM based on the waveform designation signal dCOM supplied from the control unit 4. For example, each of the plurality of drive signals COM generated by the drive signal generation unit 2 includes a waveform defined by the waveform designation signal dCOM. The drive signal generation unit 2 outputs the plurality of drive signals COM generated based on the waveform designation signal dCOM to a switching circuit 18 included in the liquid jetting head 1.

The storage unit 5 is configured to include one or both of a volatile memory, such as a random access memory (RAM), and a non-volatile memory, such as a read only memory (ROM), an electrically erasable programmable read-only memory (EEPROM), and a programmable ROM (PROM). The storage unit 5 may be included in the control unit 4.

The liquid jetting head 1 has the switching circuit 18, a recording head 10, and a detection circuit 19. The detection circuit 19 is an example of a “detection portion”.

The recording head 10 includes M jetting portions D. In the present embodiment, a case where a value M is an even number of 2 or more is assumed. Hereinafter, among the M jetting portions D provided in the recording head 10, an m-th jetting portion D will be referred to as a jetting portion D[m] in some cases. Herein, a variable m is a natural number that satisfies “1≤m≤M”. In addition, hereinafter, when a component, a signal, or the like of the liquid jetting apparatus 100 corresponds to the jetting portion D[m] among the M jetting portions D, a suffix [m] may be added to reference numerals for representing the component, the signal, or the like.

The switching circuit 18 switches whether or not to supply each drive signal COM to the jetting portion D[m] based on the print signal SI. Hereinafter, as illustrated in FIG. 5 and the like to be described later, the drive signal COM supplied to the jetting portion D[m] among the plurality of drive signals COM will be referred to as an individual drive signal Vin[m] in some cases. In addition, the switching circuit 18 switches whether or not to electrically couple the jetting portion D[m] and the detection circuit 19 based on the print signal SI. When the jetting portion D[m] and the detection circuit 19 are electrically coupled, for example, a detection signal Vout[m] detected from the jetting portion D[m] is supplied to the detection circuit 19 via the switching circuit 18. The detection signal Vout[m] is, for example, an analog signal indicating a waveform of residual vibration, which is vibration remaining in the jetting portion D[m] after the jetting portion D[m] is driven by the individual drive signal Vin[m]. Specifically, for example, the detection signal Vout[m] indicates a waveform of residual vibration of a vibration plate 14 after a piezoelectric element PZ[m] is driven. A piezoelectric element PZ and the vibration plate 14 will be described later with reference to FIGS. 3 and 4.

The detection circuit 19 generates a residual vibration signal VR[m] based on the detection signal Vout[m]. For example, the detection circuit 19 amplifies an amplitude of the detection signal Vout[m] or removes a noise component included in the detection signal Vout[m] to shape the detection signal Vout[m] into a waveform suitable for a process in the analysis portion 3. Accordingly, the residual vibration signal VR[m] is generated. For example, the detection circuit 19 may have a configuration including a negative feedback type amplifier for amplifying the detection signal Vout[m], a low-pass filter for attenuating a high-frequency component of the detection signal Vout[m], and a voltage follower that converts an impedance and that outputs the residual vibration signal VR[m] of a low impedance.

For example, the residual vibration signal VR[m] generated based on the detection signal Vout[m] is an analog signal indicating a waveform of residual vibration of the vibration plate 14 after the piezoelectric element PZ[m] is driven by the individual drive signal Vin[m]. The detection circuit 19 outputs the residual vibration signal VR[m] generated based on the detection signal Vout[m] to the analysis portion 3. As described above, the detection circuit 19 detects the residual vibration of the vibration plate 14 caused by driving the piezoelectric element PZ[m] based on the detection signal Vout[m].

The analysis portion 3 includes, for example, an analog to digital converter (ADC) and converts the analog residual vibration signal VR[m] into a digital signal. Then, the analysis portion 3 analyzes, for example, residual vibration detected by the detection circuit 19 using the residual vibration signal VR[m] converted into a digital signal. In addition, the analysis portion 3 generates residual vibration information Vinf indicating analysis results of the residual vibration and outputs the generated residual vibration information Vinf to the control unit 4. The residual vibration information Vinf indicates, for example, an amplitude and a phase of the residual vibration. However, the residual vibration information Vinf may indicate one of the amplitude and the phase of the residual vibration. Alternatively, the residual vibration information Vinf may include information indicating a period of the residual vibration or may include information indicating other than the amplitude, the phase, and the period of the residual vibration. The evaluation control portion 40 described above evaluates, for example, variations in jetting characteristics of the nozzle N based on the residual vibration information Vinf. The analysis portion 3 may be included in the control unit 4. For example, the control unit 4 may function as the analysis portion 3 by operating in accordance with the control program PG stored in the storage unit 5. In addition, a part of the analysis portion 3 may be included in the control unit 4. Specifically, the ADC may be provided outside the control unit 4, and the control unit 4 may have a function of analyzing the residual vibration by using a residual vibration signal VR converted into a digital signal.

In addition, in the present embodiment, as described above, the maintenance process is performed by the maintenance unit 7. For example, the maintenance unit 7 performs the maintenance process under the control of the control unit 4. For example, the maintenance process includes a flushing process of discharging an ink from the jetting portion D, a wiping process of wiping off a foreign matter such as an ink adhering to the vicinity of the nozzle N of the jetting portion D with a wiper, and a pumping process of suctioning the ink in the jetting portion D with a tube pump or the like.

The maintenance unit 7 has a discharged ink receiving portion for receiving a discharged ink when an ink in the jetting portion D is discharged in the flushing process, the wiper for wiping off a foreign matter such as an ink adhering to the vicinity of the nozzle N of the jetting portion D, and the tube pump for suctioning the ink, air bubbles, and the like in the jetting portion D. The discharged ink receiving portion, the wiper, and the tube pump are not illustrated.

Next, a schematic overall configuration of the liquid jetting apparatus 100 will be described with reference to FIG. 2.

FIG. 2 is a configuration diagram schematically illustrating the liquid jetting apparatus 100. In FIG. 2, the ink container 60, the medium transport mechanism 8, and the carriage transport mechanism 9 will be mainly described.

The ink container 60 stores an ink. As the ink container 60, for example, a cartridge that can be attached to and detached from the liquid jetting apparatus 100, a bag-shaped ink pack formed of a flexible film, an ink tank that can be replenished with an ink, or the like can be adopted. A type of ink stored in the ink container 60 is not particularly limited, and any type of ink may be adopted. In the present embodiment, as described above, a case where the liquid jetting apparatus 100 includes the four liquid jetting heads 1 corresponding to the four types of inks of cyan, magenta, yellow, and black, respectively, is assumed. For this reason, in the present embodiment, the ink container 60 stores the four types of inks of cyan, magenta, yellow, and black. In addition, the ink container 60 supplies the stored inks to the liquid jetting head 1.

The medium transport mechanism 8 transports the medium PP in a Y1 direction along a Y-axis under the control of the control unit 4. Hereinafter, the Y1 direction and a Y2 direction opposite to the Y1 direction will be collectively referred to as a Y-axis direction. In addition, hereinafter, an X1 direction along an X-axis that intersects the Y-axis and an X2 direction opposite to the X1 direction will be collectively referred to as an X-axis direction. In addition, hereinafter, a Z1 direction along a Z-axis that intersects the X-axis and the Y-axis and a Z2 direction opposite to the Z1 direction will be collectively referred to as a Z-axis direction. In the present embodiment, for example, description will be made by assuming a case where the X-axis, the Y-axis, and the Z-axis are orthogonal to each other. Meanwhile, the present disclosure is not limited to such an aspect. The X-axis, the Y-axis, and the Z-axis may intersect one another.

The carriage transport mechanism 9 reciprocates the plurality of liquid jetting heads 1 in the X1 direction and the X2 direction under the control of the control unit 4. As illustrated in FIG. 2, the carriage transport mechanism 9 has the substantially box-shaped carriage 91 that accommodates the plurality of liquid jetting heads 1 and an endless belt 92 to which the carriage 91 is fixed. The ink container 60 may be stored in the carriage 91 together with the liquid jetting heads 1.

The liquid jetting head 1 is driven by the drive signal COM under the control of the print signal SI and jets an ink in the Z1 direction from some or all of the plurality of nozzles N provided in the liquid jetting head 1. That is, the liquid jetting head 1 forms a desired image on a surface of the medium PP by jetting the ink from the some or all of the plurality of nozzles N in conjunction with transport of the medium PP by the medium transport mechanism 8 and reciprocation of the liquid jetting head 1 by the carriage transport mechanism 9 and landing the jetted ink on the surface of the medium PP. In the present embodiment, as described above, the Z1 direction is a direction of jetting the ink from the nozzle N.

Next, a schematic structure of the liquid jetting head 1 will be described with reference to FIGS. 3 and 4.

FIG. 3 is an exploded perspective view of the liquid jetting head 1. FIG. 4 is a sectional view taken along line IV-IV illustrated in FIG. 3. The cross section taken along line IV-IV is parallel to an XZ plane and passes through inlets HL1 and HL2 to be described later. In FIGS. 3 and 4, in order to distinguish two nozzle rows Ln to be described later from one another, the number “1” or “2” is added to the end of the reference numeral of the nozzle row Ln. In addition, in FIGS. 3 and 4, in order to facilitate understanding of the description, the number “1” is added to the end of the reference numeral of the nozzle N included in a nozzle row Ln1, and the number “2” is added to the end of the reference numeral of the nozzle N included in a nozzle row Ln2.

As illustrated in FIGS. 3 and 4, the liquid jetting head 1 includes a nozzle substrate 11, compliance sheets CS1 and CS2, a communication plate 12, a pressure chamber substrate 13, the vibration plate 14, a sealing substrate 15, a flow path forming substrate 16, and a wiring substrate 17 on which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 3, the recording head 10 includes, for example, the nozzle substrate 11, the compliance sheets CS1 and CS2, the communication plate 12, the pressure chamber substrate 13, the vibration plate 14, the sealing substrate 15, and the flow path forming substrate 16.

The nozzle substrate 11 is a plate-shaped member elongated in the Y-axis direction and extending substantially parallel to an XY plane. Herein, “substantially parallel” is a concept that includes not only a case of being completely parallel but also a case of being considered to be parallel in consideration of an error. In the present embodiment, “substantially parallel” is a concept that includes a case of being considered to be parallel in consideration of an error of approximately 10%. “Substantially vertical” to be described later is also a concept that includes a case of being considered to be vertical in consideration of an error, in addition to a case of being completely vertical, as in the case of “substantially parallel”. The nozzle substrate 11 is manufactured, for example, by processing a silicon single crystal substrate using semiconductor manufacturing techniques, such as etching, but any known material and manufacturing method may be adopted to manufacture the nozzle substrate 11.

M nozzles N are formed in the nozzle substrate 11. Herein, the nozzle Nis a through-hole provided in the nozzle substrate 11. In the present embodiment, a case where the plurality of nozzles N formed in the nozzle substrate 11 include a plurality of nozzles N1 arranged to extend in the Y-axis direction and a plurality of nozzles N2 arranged to extend in the Y-axis direction at positions in the X2 direction when viewed from the plurality of nozzles N1 is assumed. Hereinafter, the plurality of nozzles N1 arranged to extend in the Y-axis direction will be referred to as the nozzle row Ln1, and the plurality of nozzles N2 arranged to extend in the Y-axis direction will be referred to as the nozzle row Ln2. For example, the number of nozzles N included in each of the nozzle rows LN1 and Ln2 is half the value M. Hereinafter, the nozzle row Ln1 and the nozzle row Ln2 will be collectively referred to as the nozzle row Ln in some cases. In addition, in FIGS. 3 and 4, in order to facilitate understanding of the description, in the liquid jetting head 1, the number “1” is added to the end of the reference numeral of the component corresponding to the nozzle row Ln1, and the number “2” is added to the end of the reference numeral of the component corresponding to the nozzle row Ln2.

As illustrated in FIGS. 3 and 4, the communication plate 12 is provided at a position in the Z2 direction when viewed from the nozzle substrate 11. The communication plate 12 is a plate-shaped member elongated in the Y-axis direction and extending substantially parallel to the XY plane. The communication plate 12 is manufactured, for example, by processing a silicon single crystal substrate using semiconductor manufacturing techniques, and any known material and manufacturing method may be adopted to manufacture the communication plate 12.

A flow path for an ink is formed in the communication plate 12. Specifically, in the communication plate 12, one supply flow path BA1 provided to extend in the Y-axis direction and one supply flow path BA2 provided to extend in the Y-axis direction at a position in the X2 direction when viewed from the supply flow path BA1 are formed. In addition, in the communication plate 12, a plurality of coupling flow paths BK1 corresponding to the plurality of nozzles N1, a plurality of coupling flow paths BK2 corresponding to the plurality of nozzles N2, a plurality of communication flow paths BR1 corresponding to the plurality of nozzles N1, and a plurality of communication flow paths BR2 corresponding to the plurality of nozzles N2 are formed.

As illustrated in FIG. 4, the coupling flow path BK1 is provided to communicate with the supply flow path BA1 and to extend in the Z-axis direction at a position in the X2 direction when viewed from the supply flow path BA1. The communication flow path BR1 is provided to extend in the Z-axis direction at a position in the X2 direction when viewed from the coupling flow path BK1. The communication flow path BR1 communicates with the nozzle N1 corresponding to the communication flow path BR1. The coupling flow path BK2 is provided to communicate with the supply flow path BA2 and to extend in the Z-axis direction at a position in the X1 direction when viewed from the supply flow path BA2. The communication flow path BR2 is provided to extend in the Z-axis direction at a position in the X1 direction when viewed from the coupling flow path BK2 and in the X2 direction when viewed from the communication flow path BR1. The communication flow path BR2 communicates with the nozzle N2 corresponding to the communication flow path BR2.

The supply flow paths BA1 and BA2 will also be referred to as a supply flow path BA without particularly distinguishing therebetween, the coupling flow paths BK1 and BK2 will also be referred to as a coupling flow path BK without particularly distinguishing therebetween, and the communication flow paths BR1 and BR2 will also be referred to as a communication flow path BR without particularly distinguishing therebetween.

The pressure chamber substrate 13 is provided at a position in the Z2 direction when viewed from the communication plate 12, as illustrated in FIGS. 3 and 4. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing techniques, but any known material and manufacturing method may be adopted to manufacture the pressure chamber substrate 13.

A flow path for an ink is formed in the pressure chamber substrate 13. Specifically, the pressure chamber substrate 13 is formed with a plurality of pressure chambers CV1 corresponding to the plurality of nozzles N1 and a plurality of pressure chambers CV2 corresponding to the plurality of nozzles N2. Among these, the pressure chamber CV1 is provided to join an end portion of the coupling flow path BK1 in the X2 direction and an end portion of the communication flow path BR1 in the X1 direction when viewed in the Z-axis direction and to extend in the X-axis direction. When viewed in the Z-axis direction, the pressure chamber CV2 is provided to join an end portion of the coupling flow path BK2 in the X1 direction and an end portion of the communication flow path BR2 in the X2 direction and to extend in the X-axis direction. The pressure chambers CV1 and CV2 will also be referred to as a pressure chamber CV without particularly distinguishing therebetween.

The vibration plate 14 is provided at a position in the Z2 direction when viewed from the pressure chamber substrate 13, as illustrated in FIGS. 3 and 4. The vibration plate 14 is a plate-shaped member elongated in the Y-axis direction and extending substantially parallel to the XY plane and is a member that can vibrate elastically. In the present embodiment, the vibration plate 14 includes, for example, an elastic layer made of silicon oxide and an insulating layer made of zirconium oxide provided at a position in the Z2 direction when viewed from the elastic layer. That is, in the present embodiment, a surface of the vibration plate 14 in the Z2 direction is formed of a non-conductive member. Herein, a surface of an element A in a first direction is a surface, which is substantially vertical to the first direction, among surfaces of the element A, and is a surface which is visible when the element A is viewed from the first direction to a second direction. The second direction is a direction opposite to the first direction. The elastic layer included in the vibration plate 14 is not limited to the elastic layer made of silicon oxide. Similarly, the insulating layer included in the vibration plate 14 is not limited to the insulating layer made of zirconium oxide.

As illustrated in FIGS. 3 and 4, a plurality of piezoelectric elements PZ1 corresponding to the plurality of pressure chambers CV1 and a plurality of piezoelectric elements PZ2 corresponding to the plurality of pressure chambers CV2 are provided at positions in the Z2 direction when viewed from the vibration plate 14. The piezoelectric elements PZ1 and PZ2 will also be referred to as the piezoelectric element PZ without particularly distinguishing therebetween. The piezoelectric element PZ is driven by the drive signal COM being supplied.

Although not illustrated in FIGS. 3 and 4, the piezoelectric element PZ has a common electrode Zc to which a predetermined bias potential VBS is supplied, an individual electrode Za to which the individual drive signal Vin is supplied, and a piezoelectric body Zb provided between the individual electrode Za and the common electrode Zc, as illustrated in FIG. 5. For example, the individual electrode Za, the piezoelectric body Zb, and the common electrode Zc are provided in this order along the Z2 direction at the surface of the vibration plate 14 in the Z2 direction. Herein, an expression “an element B is formed at the surface of the element A” in the present specification is not intended to limit the configuration to a configuration where the element A and the element B come into direct contact with one another. That is, a configuration where an element Cis formed at the surface of the element A and the element B is formed at a surface of the element C is also included in the concept “the element B is formed at the surface of the element A” insofar as at least a part of the element A and a part of the element B overlap in plan view. In the present embodiment, the common electrode Zc is a so-called upper electrode, and the individual electrode Za is a so-called lower electrode. However, the common electrode Zc may be a lower electrode, and the individual electrode Za may be an upper electrode.

The piezoelectric element PZ is a passive element that is deformed according to a potential change of the drive signal COM supplied to the individual electrode Za as the individual drive signal Vin. In other words, the piezoelectric element PZ is an example of an energy conversion element that converts electrical energy of the drive signal COM into kinetic energy. Specifically, the piezoelectric element PZ is driven and deformed according to the potential change of the drive signal COM.

As illustrated in FIGS. 3 and 4, since the piezoelectric element PZ is provided at the surface of the vibration plate 14 in the Z2 direction, the vibration plate 14 vibrates in conjunction with the deformation of the piezoelectric element PZ. That is, the vibration plate 14 vibrates by driving the piezoelectric element PZ. When the vibration plate 14 vibrates, a pressure in the pressure chamber CV fluctuates. Then, an ink filling the inside of the pressure chamber CV is jetted from the nozzle N via the communication flow path BR as the pressure in the pressure chamber CV fluctuates. As described above, the pressure chamber CV is filled with the ink, and the pressure for jetting the ink from the nozzle N is applied by the vibration of the vibration plate 14. In addition, vibration remaining in the jetting portion D[m] illustrated in FIG. 1 is also considered as, for example, vibration remaining in the ink in the pressure chamber CV of the jetting portion D.

The sealing substrate 15 for protecting the plurality of piezoelectric elements PZ1 and the plurality of piezoelectric elements PZ2 is provided at a position in the Z2 direction when viewed from the pressure chamber substrate 13, as illustrated in FIGS. 3 and 4. The sealing substrate 15 is a plate-shaped member elongated in the Y-axis direction and extending substantially parallel to the XY plane. The sealing substrate 15 is manufactured, for example, by processing a silicon single crystal substrate using semiconductor manufacturing techniques, and any known material and manufacturing method may be adopted to manufacture the sealing substrate 15.

As illustrated in FIG. 4, a surface of the sealing substrate 15 in the Z1 direction is provided with a recess portion for covering the plurality of piezoelectric elements PZ1 and a recess portion for covering the plurality of piezoelectric elements PZ2. Hereinafter, a sealing space covering the plurality of piezoelectric elements PZ1 and formed between the vibration plate 14 and the sealing substrate 15 will be referred to as a sealing space SP1, and a sealing space covering the plurality of piezoelectric elements PZ2 and formed between the vibration plate 14 and the sealing substrate 15 will be referred to as a sealing space SP2. In addition, the sealing spaces SP1 and SP2 will also be referred to as a sealing space SP without particularly distinguishing therebetween. The sealing space SP is a space for sealing the piezoelectric element PZ and preventing the piezoelectric element PZ from deteriorating due to an effect of moisture or the like.

The sealing substrate 15 is provided with a through-hole 15h. The through-hole 15h is a hole that is positioned between the sealing space SP1 and the sealing space SP2 when the sealing substrate 15 is viewed in the Z1 direction and that penetrates from the surface of the sealing substrate 15 in the Z1 direction to a surface of the sealing substrate 15 in the Z2 direction. The wiring substrate 17 is inserted into the through-hole 15h.

The flow path forming substrate 16 is provided at a position in the Z2 direction when viewed from the communication plate 12, as illustrated in FIGS. 3 and 4. The flow path forming substrate 16 is a plate-shaped member elongated in the Y-axis direction and extending substantially parallel to the XY plane. The flow path forming substrate 16 is formed through, for example, injection molding of a resin material, but any known material and manufacturing method may be adopted to manufacture the flow path forming substrate 16.

As illustrated in FIG. 4, a flow path for an ink is formed in the flow path forming substrate 16. Specifically, the flow path forming substrate 16 is formed with one supply flow path BB1 and one supply flow path BB2. Among these, the supply flow path BB1 is provided to communicate with the supply flow path BA1 and to extend in the Y-axis direction at a position in the Z2 direction when viewed from the supply flow path BA1. The supply flow path BB2 is provided to communicate with the supply flow path BA2 and to extend in the Y-axis direction at a position in the Z2 direction when viewed from the supply flow path BA2, which is a position in the X2 direction when viewed from the supply flow path BB1. The supply flow paths BB1 and BB2 will also be referred to as a supply flow path BB without particularly distinguishing therebetween.

The flow path forming substrate 16 is provided with the inlet HL1 communicating with the supply flow path BB1 and the inlet HL2 communicating with the supply flow path BB2. An ink is supplied from the ink container 60 to the supply flow path BB1 via the inlet HL1. The ink supplied from the ink container 60 to the supply flow path BB1 via the inlet HL1 flows into the supply flow path BA1. A part of the ink flowing into the supply flow path BA1 fills the pressure chamber CV1 via the coupling flow path BK1. When the piezoelectric element PZ1 is driven by the drive signal COM, a part of the ink filling the pressure chamber CV1 is jetted from the nozzle N1 via the communication flow path BR1.

In addition, an ink is supplied from the ink container 60 to the supply flow path BB2 via the inlet HL2. The ink supplied from the ink container 60 to the supply flow path BB2 via the inlet HL2 flows into the supply flow path BA2. A part of the ink flowing into the supply flow path BA2 fills the pressure chamber CV2 via the coupling flow path BK2. When the piezoelectric element PZ2 is driven by the drive signal COM, a part of the ink filling the pressure chamber CV2 is jetted from the nozzle N2 via the communication flow path BR2.

The flow path forming substrate 16 is provided with a through-hole 16h. The through-hole 16h is a hole that is positioned between the supply flow path BB1 and the supply flow path BB2 when the flow path forming substrate 16 is viewed in the Z1 direction and that penetrates from a surface of the flow path forming substrate 16 in the Z1 direction to a surface of the flow path forming substrate 16 in the Z2 direction. The wiring substrate 17 is inserted into the through-hole 16h.

As illustrated in FIGS. 3 and 4, the wiring substrate 17 is mounted on the surface of the vibration plate 14 in the Z2 direction. The wiring substrate 17 is a component for electrically coupling the liquid jetting head 1 to the control unit 4. As the wiring substrate 17, for example, a flexible wiring substrate such as a flexible printed circuit (FPC) and a flexible flat cable (FFC) is preferably adopted. As described above, the electronic component EC including the switching circuit 18 and the detection circuit 19 is mounted on the wiring substrate 17.

As illustrated in FIGS. 3 and 4, at positions in the Z1 direction when viewed from the communication plate 12, the compliance sheet CS1 is provided to close the supply flow path BA1 and the coupling flow path BK1, and the compliance sheet CS2 is provided to close the supply flow path BA2 and the coupling flow path BK2. The compliance sheets CS1 and CS2 will also be referred to as a compliance sheet CS without particularly distinguishing therebetween. The compliance sheet CS is a plate-shaped member elongated in the Y-axis direction and extending substantially parallel to the XY plane. The compliance sheet CS is formed of an elastic material and absorbs ink pressure fluctuations in the supply flow path BA and the coupling flow path BK.

Herein, as illustrated in FIG. 4, a jetting portion D1 has the piezoelectric element PZ1, the pressure chamber CV1, the nozzle N1 communicating with the pressure chamber CV1, and a portion of the vibration plate 14 that comes into contact with the piezoelectric element PZ1. Similarly, a jetting portion D2 has the piezoelectric element PZ2, the pressure chamber CV2, the nozzle N2 communicating with the pressure chamber CV2, and a portion of the vibration plate 14 that comes into contact with the piezoelectric element PZ2. The jetting portions D1 and D2 will also be referred to as the jetting portion D without particularly distinguishing therebetween.

In addition, although not illustrated, the liquid jetting head 1 has a cap for sealing a nozzle surface, which is a surface of the nozzle substrate 11 in the Z1 direction. The cap seals the nozzle surface of the nozzle substrate 11 where the nozzle N is formed, in a period when an ink is not jetted from the nozzle N.

Next, an outline of the liquid jetting head 1 will be described with reference to FIG. 5.

FIG. 5 is a block diagram illustrating an example of a configuration of the liquid jetting head 1.

As described in FIG. 1, the liquid jetting head 1 has the recording head 10, the switching circuit 18, and the detection circuit 19. In addition, the liquid jetting head 1 has wiring La to which the drive signal COMa is supplied from the drive signal generation unit 2 and wiring Lb to which the drive signal COMb is supplied from the drive signal generation unit 2. Further, the liquid jetting head 1 has wiring Ls that supplies a detection signal Vout to the detection circuit 19, wiring Li[m] that supplies the individual drive signal Vin[m] to the jetting portion D[m], and wiring Ld to which the bias potential VBS is supplied.

The switching circuit 18 has M switches SWa[1] to SWa[M] corresponding to the M jetting portions D[1] to D[M] on a one-to-one basis, M switches SWb[1] to SWb[M] corresponding to the M jetting portions D[1] to D[M] on a one-to-one basis, and M switches SWs[1] to SWs[M] corresponding to the M jetting portions D[1] to D[M] on a one-to-one basis.

In addition, the switching circuit 18 has a coupling state designation circuit CSC. The coupling state designation circuit CSC designates a coupling state of each of the M switches SWa, the M switches SWb, and the M switches SWs. For example, the coupling state designation circuit CSC generates coupling state designation signals Qa[m], Qb[m], and Qs[m] based on at least one signal of the print signal SI and a latch signal LAT supplied from the control unit 4.

For example, the coupling state designation signal Qa[m] is a signal for designating on or off of the switch SWa[m], and the coupling state designation signal Qb[m] is a signal for designating on or off of the switch SWb[m]. In addition, the coupling state designation signal Qs[m] is a signal for designating on or off of the switch SWs[m].

The switch SWa[m] switches between conduction and non-conduction between the wiring La and the individual electrode Za[m] of the piezoelectric element PZ[m] provided in the jetting portion D[m] based on the coupling state designation signal Qa[m]. That is, the switch SWa[m] switches between conduction and non-conduction between the wiring La and the wiring Li[m] coupled to the individual electrode Za[m] based on the coupling state designation signal Qa[m]. In the present embodiment, the switch SWa[m] is turned on when the coupling state designation signal Qa[m] is at a high level and is turned off when the coupling state designation signal Qa[m] is at a low level. When the switch SWa[m] is turned on, the drive signal COMa supplied to the wiring La is supplied to the individual electrode Za[m] of the jetting portion D[m] as the individual drive signal Vin[m] via the wiring Li[m].

The switch SWb[m] switches between conduction and non-conduction between the wiring Lb and the individual electrode Za[m] of the piezoelectric element PZ[m] provided in the jetting portion D[m] based on the coupling state designation signal Qb[m]. That is, the switch SWb[m] switches between conduction and non-conduction between the wiring Lb and the wiring Li[m] coupled to the individual electrode Za[m] based on the coupling state designation signal Qb[m]. In the present embodiment, the switch SWb[m] is turned on when the coupling state designation signal Qb[m] is at a high level and is turned off when the coupling state designation signal Qb[m] is at a low level. When the switch SWb[m]] is turned on, the drive signal COMb supplied to the wiring Lb is supplied to the individual electrode Za[m] of the jetting portion D[m] as the individual drive signal Vin[m] via the wiring Li[m].

The switch SWs[m] switches between conduction and non-conduction between the wiring Ls and the individual electrode Za[m] of the piezoelectric element PZ[m] provided in the jetting portion D[m] based on the coupling state designation signal Qs[m]. That is, the switch SWs[m] switches between conduction and non-conduction between the wiring Ls and the wiring Li[m] coupled to the individual electrode Za[m] based on the coupling state designation signal Qs[m]. In the present embodiment, the switch SWs[m] is turned on when the coupling state designation signal Qs[m] is at a high level and is turned off when the coupling state designation signal Qs[m] is at a low level.

For example, the coupling state designation signal Qs[m] becomes a high level when the residual vibration of the jetting portion D[m] is detected. Hereinafter, the jetting portion D in which the residual vibration is detected will be referred to as a detection target jetting portion D in some cases. As the switch SWs[m] is turned on, the detection signal Vout[m] indicating the potential of the individual electrode Za[m] of the piezoelectric element PZ[m] included in a detection target jetting portion D[m] is supplied to the detection circuit 19 via the wiring Li[m] and the wiring Ls. The detection circuit 19 generates the residual vibration signal VR[m] based on the detection signal Vout[m].

As described above, the individual drive signal Vin[m] is a signal supplied to the piezoelectric element PZ[m] included in the jetting portion D[m] via the switch SWa[m] or SWb[m], among the drive signals COMa and COMb. In the present embodiment, a case where the drive signal COMa is the drive signal COM for jetting an ink from the nozzle N and the drive signal COMb is the drive signal COM for not jetting the ink from the nozzle N is assumed.

Herein, depending on an image to be printed, continuous jetting in which an ink is continuously jetted in a plurality of pixels forming the image and single jetting in which the ink is jetted in only one pixel among the plurality of pixels are mixed in some cases. In the continuous jetting, jetting driving, in which the piezoelectric element PZ is driven by the drive signal COMa for jetting the ink from the nozzle N, is continuously performed. On the other hand, in the single jetting, the jetting driving described above is not continuous. For this reason, there is a possibility that jetting characteristics of the nozzle N vary between the continuous jetting and the single jetting. The single jetting is one type of the discontinuous jetting described above.

In order to suppress thickening of an ink, it is known that the ink in the pressure chamber CV is slightly vibrated by performing non-jetting driving in which the piezoelectric element PZ is driven by the drive signal COMb for not jetting the ink from the nozzle N. In the present embodiment, a case where the non-jetting driving is performed with respect to the jetting portion D in which the jetting driving is not performed is assumed. In this aspect, variations in jetting characteristics between the continuous jetting and the discontinuous jetting can be reduced by adjusting the waveform of the drive signal COMb. Therefore, in the present embodiment, for example, occurrence of the variations in the jetting characteristics of the nozzle N are suppressed by making the waveform of the drive signal COMb an appropriate waveform. The non-jetting driving is an example of “minute vibration driving”, and the jetting driving is an example of “vibration driving”.

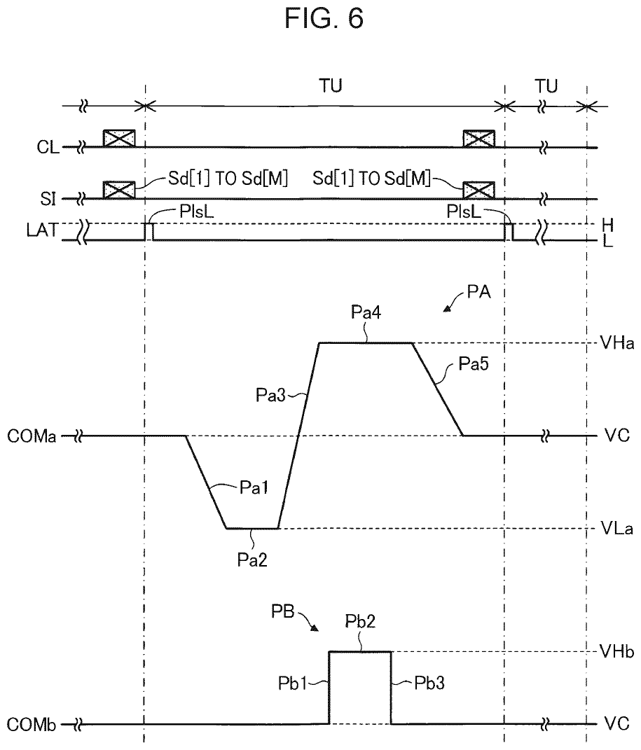

Next, an operation of the liquid jetting apparatus 100 in a unit period TU will be described with reference to FIG. 6.

FIG. 6 is a timing chart illustrating an example of the operation of the liquid jetting apparatus 100 in the unit period TU. In the present embodiment, when the liquid jetting apparatus 100 performs the printing process, a printing process period including one or a plurality of unit periods TU is set as an operation period of the liquid jetting apparatus 100. The liquid jetting apparatus 100 according to the present embodiment can drive each jetting portion D for the printing process in each unit period TU. In addition, the liquid jetting apparatus 100 according to the present embodiment can drive the detection target jetting portion D and detect the detection signal Vout[m] from the detection target jetting portion D in each unit period TU.

The control unit 4 outputs the latch signal LAT having a pulse PlsL. Accordingly, the control unit 4 defines the unit period TU as a period from rising of the pulse PlsL to rising of the next pulse PlsL.

The print signal SI includes, for example, M individual designation signals Sd[1] to Sd[M] corresponding to the M jetting portions D[1] to D[M] on a one-to-one basis. The individual designation signal Sd[m] designates an aspect of driving of the jetting portion D[m] in each unit period TU when the liquid jetting apparatus 100 performs the printing process.

The control unit 4 supplies the print signal SI including the individual designation signals Sd[1] to Sd[M] to the coupling state designation circuit CSC in synchronization with a clock signal CL prior to each unit period TU when the printing process is performed. Then, the coupling state designation circuit CSC generates the coupling state designation signals Qa[m], Qb[m], and Qs[m] based on the individual designation signal Sd[m] in the unit period TU.

For example, the jetting portion D[m] is designated by the individual designation signal Sd[m] to any one of the jetting portion D that forms a dot, the jetting portion D that does not form a dot, and the detection target jetting portion D in the unit period TU when the printing process is performed. The jetting portion D that forms a dot is the jetting portion D in which the piezoelectric element PZ of the jetting portion D is driven such that an ink is jetted from the nozzle N of the jetting portion D. In addition, the jetting portion D that does not form a dot is the jetting portion D in which the piezoelectric element PZ of the jetting portion D is driven such that the ink is not jetted from the nozzle N of the jetting portion D. In the present embodiment, the jetting portion D that does not form a dot is driven such that minute vibration is generated in a portion of the vibration plate 14 corresponding to the jetting portion D to such an extent that the ink is not jetted from the nozzle N.

First, an operation of the coupling state designation circuit CSC or the like when a driving aspect of the jetting portion D that forms a dot is designated by the individual designation signal Sd[m] will be described. When the driving aspect of the jetting portion D that forms a dot is designated by the individual designation signal Sd[m], for example, the coupling state designation circuit CSC sets the coupling state designation signal Qa[m] to a high level and the coupling state designation signals Qb[m] and Qs[m] to a low level in the unit period TU. Accordingly, the drive signal COMa is supplied from the drive signal generation unit 2 to the jetting portion D that forms a dot.

For example, the drive signal generation unit 2 outputs the drive signal COMa having a vibration pulse PA. Driving the piezoelectric element PZ with the drive signal COMa can also be considered as driving the piezoelectric element PZ with the vibration pulse PA. The vibration pulse PA is, for example, a pulse that causes the vibration plate 14 to generate vibration larger than vibration of the vibration plate 14 caused by the non-jetting driving in which the piezoelectric element PZ is driven with a minute vibration pulse PB to be described later. In the present embodiment, the vibration pulse PA is a pulse for jetting an ink from the nozzle N.

For example, the vibration pulse PA is a waveform in which the potential of the drive signal COMa changes from a potential VC to a potential VLa and a potential VHa and then returns to the potential VC. The potential VC is a potential at the start and the end of the vibration pulse PA and is a reference potential of the drive signal COMa. In addition, the potential VLa is a potential lower than the potential VC, and the potential VHa is a potential higher than the potential VC.

For example, the vibration pulse PA has a waveform element Pa1 in which the potential changes from the potential VC to the potential VLa, a waveform element Pa2 in which the potential is maintained at the potential VLa at the end of the waveform element Pa1, and a waveform element Pa3 in which the potential changes from the potential VLa to the potential VHa. The vibration pulse PA further includes a waveform element Pa4 in which the potential is maintained at the potential VHa at the end of the waveform element Pa3 and a waveform element Pa5 in which the potential changes from the potential VHa to the potential VC.

The waveform elements Pa1 and Pa5 are expansion elements for displacing the piezoelectric body Zb in the Z2 direction. In the expansion element, the potential of the drive signal COMa changes in order to drive the piezoelectric element PZ such that the volume of the pressure chamber CV is expanded. Therefore, in the waveform elements Pa1 and Pa5, the potential of the drive signal COMa changes to expand the volume of the pressure chamber CV. When the volume of the pressure chamber CV expands, a surface of an ink in the nozzle N is pulled in the Z2 direction, which is a direction opposite to the jetting direction. Hereinafter, the pulling of the surface of the ink in the nozzle N in the direction opposite to the jetting direction will be referred to as a pull in some cases.

In addition, the waveform element Pa3 is a contraction element for displacing the piezoelectric body Zb in the Z1 direction. In the contraction element, the potential of the drive signal COMa changes in order to drive the piezoelectric element PZ such that the volume of the pressure chamber CV is contracted. Therefore, in the waveform element Pa3, the potential of the drive signal COMa changes to contract the volume of the pressure chamber CV. When the volume of the pressure chamber CV is contracted, a surface of an ink in the nozzle N is pushed out in the Z1 direction, which is the jetting direction. Hereinafter, pushing the surface of the ink in the nozzle N in the jetting direction will be referred to as a push in some cases.

In addition, the waveform elements Pa2 and Pa4 are maintenance elements for maintaining the position of the piezoelectric body Zb in the Z-axis direction. For example, in the waveform element Pa2, the potential of the drive signal COMa is maintained in order to drive the piezoelectric element PZ such that the volume of the pressure chamber CV expanded by the waveform element Pa1 is maintained. In addition, for example, in the waveform element Pa4, the potential of the drive signal COMa is maintained in order to drive the piezoelectric element PZ such that the volume of the pressure chamber CV contracted by the waveform element Pa3 is maintained.

As described above, the vibration pulse PA is a so-called pull-push-pull waveform. However, the waveform of the drive signal COMa for jetting an ink from the nozzle N, that is, the waveform of the vibration pulse PA is not limited to the pull-push-pull waveform.

The vibration pulse PA is determined such that a predetermined amount of ink is jetted from the jetting portion D[m] when the individual drive signal Vin[m] having the vibration pulse PA is supplied to the jetting portion D[m]. In the present embodiment, a case where the volume of the pressure chamber CV included in the jetting portion D[m] is decreased when the potential of the individual drive signal Vin[m] is a high potential, compared to a case of a low potential, is assumed. For this reason, when the jetting portion D[m] is driven by the individual drive signal Vin[m] having the vibration pulse PA, the ink in the jetting portion D[m] is jetted from the nozzle N by the waveform element Pa3 in which the potential of the individual drive signal Vin[m] changes from the low potential to the high potential.

For example, the waveform elements Pa1, Pa2, Pa3, Pa4, and Pa5 included in the vibration pulse PA are determined based on jetting characteristics of an ink from the jetting portion D and the like. The jetting characteristics of an ink are, for example, the amount of ink jetted as ink droplets, a jetting rate of the jetted ink droplets, and the like.

Next, an operation of the coupling state designation circuit CSC or the like when a driving aspect of the jetting portion D that does not form a dot is designated by the individual designation signal Sd[m] will be described. When the driving aspect of the jetting portion D that does not form a dot is designated by the individual designation signal Sd[m], for example, the coupling state designation circuit CSC sets the coupling state designation signal Qb[m] to a high level and the coupling state designation signals Qa[m] and Qs[m] to a low level in the unit period TU. Accordingly, the drive signal COMb is supplied from the drive signal generation unit 2 to the jetting portion D that does not form a dot.

For example, the drive signal generation unit 2 outputs the drive signal COMb having the minute vibration pulse PB that does not jet an ink from the nozzle N. Driving the piezoelectric element PZ with the drive signal COMb can also be considered as driving the piezoelectric element PZ with the minute vibration pulse PB. The minute vibration pulse PB is, for example, a waveform in which the potential of the drive signal COMb changes from the potential VC to a potential VHb and then returns to the potential VC. The potential VC is a potential at the start and the end of the minute vibration pulse PB and is a reference potential of the drive signal COMb. In addition, the potential VHb is a potential higher than the potential VC. A potential difference between the potential VC and the potential VHb is set to be smaller than a potential difference between the potential VLa and the potential VHa, and the ink is not jetted from the nozzle N.

For example, the minute vibration pulse PB includes a waveform element Pb1 corresponding to a contraction element, a waveform element Pb2 corresponding to a maintenance element, and a waveform element Pb3 corresponding to an expansion element. Therefore, in the waveform element Pb1, the potential of the drive signal COMb changes in order to drive the piezoelectric element PZ such that the volume of the pressure chamber CV is contracted. In addition, in the waveform element Pb2, the potential of the drive signal COMb is maintained in order to drive the piezoelectric element PZ such that the volume of the pressure chamber CV contracted by the waveform element Pb1 is maintained. Then, in the waveform element Pb3, the potential of the drive signal COMb changes in order to drive the piezoelectric element PZ such that the volume of the pressure chamber CV is expanded.

As described above, the minute vibration pulse PB contracts the volume of the pressure chamber CV by changing the potential from the potential VC to the potential VHb and expands the volume of the contracted pressure chamber CV by changing the potential from the potential VHb to the potential VC. Due to such a change in the volume of the pressure chamber CV, an ink in the pressure chamber CV is vibrated without the ink in the pressure chamber CV being jetted. The vibration of the vibration plate 14 through the non-jetting driving in which the piezoelectric element PZ is driven with the minute vibration pulse PB is smaller than the vibration of the vibration plate 14 caused by the jetting driving in which the piezoelectric element PZ is driven with the vibration pulse PA.

Next, an operation of the coupling state designation circuit CSC or the like when a driving aspect of the detection target jetting portion D is designated by the individual designation signal Sd[m] will be described. Hereinafter, the operation of the coupling state designation circuit CSC or the like when the driving aspect of the detection target jetting portion D is designated by the individual designation signal Sd[m] will be described with reference to an example of a case of evaluating variations in jetting characteristics of the nozzle N.

For example, when evaluating variations in jetting characteristics of the nozzle N, the detection target jetting portion D is designated by the individual designation signal Sd[m] in the detection unit period TU. Accordingly, residual vibration caused by continuously performing the jetting driving or residual vibration caused by continuously driving the piezoelectric element PZ in the order of the non-jetting driving and the jetting driving is detected in the detection unit period TU. For example, when detecting the residual vibration caused by continuously performing the jetting driving, the jetting driving is performed in each of the unit period TU before two detection unit periods TU and the unit period TU before one detection unit period TU. In addition, when residual vibration caused by continuously driving the piezoelectric element PZ in the order of the non-jetting driving and the jetting driving is detected, the non-jetting driving is performed in the unit period TU before two detection unit periods TU, and the jetting driving is performed in the unit period TU before one detection unit period TU.

When the driving aspect of the detection target jetting portion D is designated by the individual designation signal Sd[m], the coupling state designation circuit CSC sets the coupling state designation signal Qs[m] to a high level in the detection unit period TU. In addition, the coupling state designation circuit CSC sets the coupling state designation signals Qa[m] and Qb[m] to a low level in the detection unit period TU.

In this case, the piezoelectric element PZ[m] included in the detection target jetting portion D[m] is driven by the drive signal COMa in the unit period TU before one detection unit period TU, as described above. Accordingly, the piezoelectric element PZ[m] is displaced by the vibration pulse PA of the drive signal COMa in the unit period TU before one detection unit period TU. As a result, vibration is generated in the detection target jetting portion D[m] in the unit period TU before one detection unit period TU. The vibration generated in the unit period TU before one detection unit period TU remains even in the detection unit period TU. Then, in the detection unit period TU, the potential of the individual electrode Za[m] of the piezoelectric element PZ[m] included in the detection target jetting portion D[m] changes according to the residual vibration generated in the jetting portion D[m]. That is, in the detection unit period TU, the potential of the individual electrode Za of the piezoelectric element PZ included in the detection target jetting portion D becomes a potential corresponding to an electromotive force of the piezoelectric element PZ caused by the residual vibration generated in the detection target jetting portion D. Then, the potential of the individual electrode Za is detected as the detection signal Vout in the detection unit period TU.

The coupling state designation signals Qa, Qb, and Qs corresponding to the jetting portions D other than the detection target jetting portion D[m] are set to a low level in the detection unit period TU, for example. In addition, the coupling state designation circuit CSC may set, for example, the coupling state designation signal Qs[m] to a high level in a first half period of the detection unit period TU and set the coupling state designation signal Qs[m] to a low level in a second half period of the detection unit period TU.

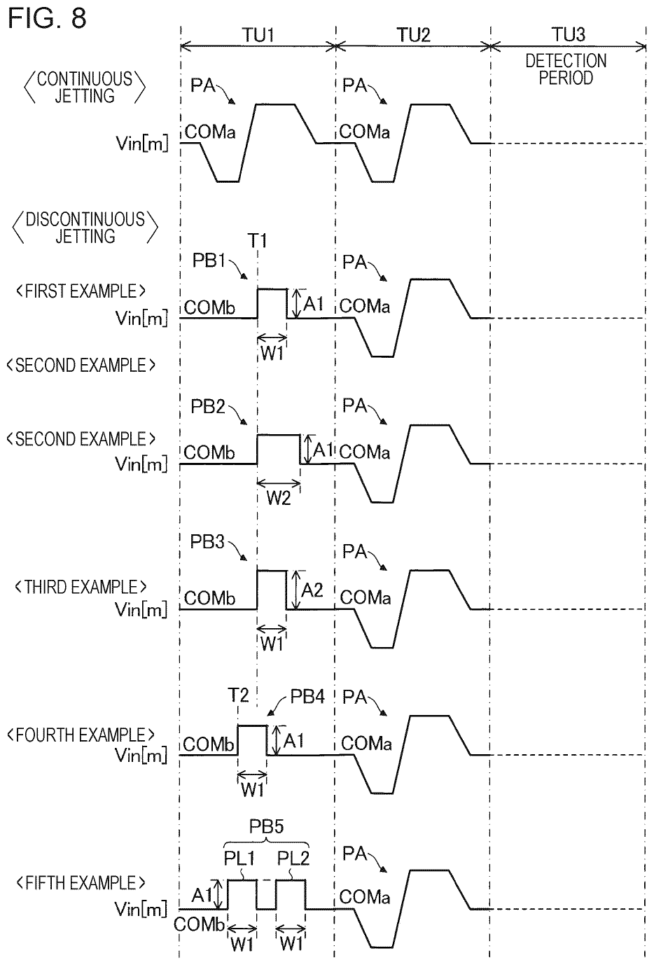

Herein, for example, jetting characteristics such as the jetting rate of ink droplets change depending on the viscosity of the ink. For example, the jetting rate of ink droplets thickened more than predetermined viscosity is lower than the jetting rate of ink droplets having viscosity equal to or lower than the predetermined viscosity. As described above, the jetting characteristics of the nozzle N change depending on the viscosity of the ink. For example, the viscosity of the ink in the unit period TU to be focused changes depending on whether or not the jetting driving has performed in the unit period TU before one unit period TU to be focused. Therefore, for example, occurrence of variations in jetting characteristics between the continuous jetting and the discontinuous jetting can be suppressed by preventing the viscosity of the ink from increasing in the discontinuous jetting. For this reason, in the present embodiment, for example, the evaluation control portion 40 evaluates variations in the jetting characteristics of the nozzle N using a plurality of candidates for the drive signal COMb. Then, the evaluation control portion 40 adopts one of the plurality of candidates described above as the drive signal COMb for not jetting the ink from the nozzle N, for example, based on evaluation results of the variations in the jetting characteristics of the nozzle N. Accordingly, an appropriate waveform is determined as the waveform of the drive signal COMb. As described above, in the present embodiment, the waveform of the drive signal COMb, that is, the waveform of the minute vibration pulse PB can be easily determined to be a waveform for suppressing the variations in the jetting characteristics of the nozzle N. In FIG. 6, one candidate minute vibration pulse PB of the plurality of candidates for the drive signal COMb is illustrated as an example of the minute vibration pulse PB included in the drive signal COMb. That is, the drive signal COMb is not limited to the example illustrated in FIG. 6. Examples of the plurality of candidates for the drive signal COMb, that is, the minute vibration pulse PB used in evaluating the variations in the jetting characteristics of the nozzle N will be described with reference to FIG. 8.

An operation of the liquid jetting apparatus 100 is not limited to the example illustrated in FIG. 6. For example, a case where there is one drive signal COM for jetting an ink from the nozzle N is illustrated in FIG. 6, but the present disclosure is not limited to such an aspect. For example, the plurality of drive signals COM corresponding to sizes of dots may be used as the drive signals COM for jetting the ink from the nozzle N. In addition, the plurality of drive signals COM may include the drive signal COM having a minute vibration waveform that generates residual vibration for detecting a jetting abnormality. When a process of detecting the residual vibration of the detection target jetting portion D having a jetting abnormality is performed in a period different from the printing process period, the jetting abnormality of the nozzle N may be detected based on the residual vibration detected by using the drive signal COMa or COMb.

In addition, the reference potential of the drive signal COMb is the same potential VC as the reference potential of the drive signal COMa in the example illustrated in FIG. 6, but the reference potential of the drive signal COMb may be a potential different from the reference potential of the drive signal COMa.

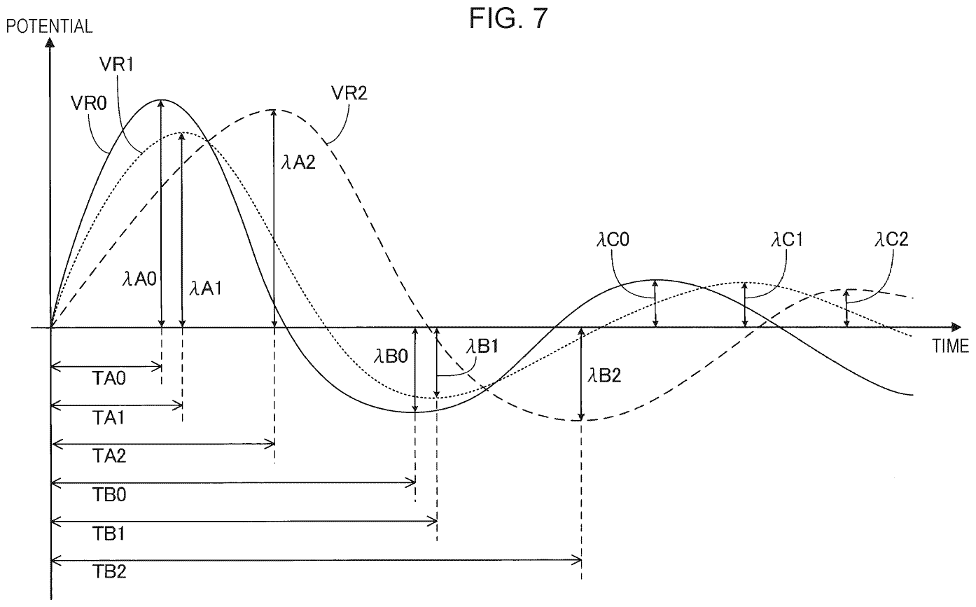

Next, an operation of the analysis portion 3 will be described with reference to FIG. 7.

FIG. 7 is a graph illustrating an example of a waveform of the residual vibration signal VR. FIG. 7 schematically illustrates an example of a waveform of the residual vibration signal VR in the continuous jetting and an example of a waveform of the residual vibration signal VR in the discontinuous jetting. The vertical axis of the graph indicates the potential of the residual vibration signal VR, and the horizontal axis indicates time.

For example, a residual vibration signal VR0 is the residual vibration signal VR indicating residual vibration caused by continuously performing the jetting driving with the drive signal COMa. In addition, for example, residual vibration signals VR1 and VR2 are the residual vibration signals VR indicating residual vibration caused by continuously performing the non-jetting driving with the drive signal COMb and the jetting driving with the drive signal COMa in this order. A waveform of the drive signal COMb used in the non-jetting driving, that is, a waveform of the minute vibration pulse PB is different between the residual vibration signal VR1 and the residual vibration signal VR2. Hereinafter, the drive signal COMb used in the non-jetting driving when detecting the residual vibration signal VR1 will also be referred to as the first drive signal COMb, and the drive signal COMb used in the non-jetting driving when detecting the residual vibration signal VR2 will also be referred to as the second drive signal COMb.

For example, a difference between the residual vibration signal VR0 and the residual vibration signal VR1 and a difference between the residual vibration signal VR0 and the residual vibration signal VR2 indicate degrees of variations in jetting characteristics between the continuous jetting and the discontinuous jetting. In the example illustrated in FIG. 7, the difference between the residual vibration signal VR0 and the residual vibration signal VR1 is smaller than the difference between the residual vibration signal VR0 and the residual vibration signal VR2. Therefore, in the example illustrated in FIG. 7, when the drive signal COMb used in detecting the residual vibration signal VR1 is adopted, variations in jetting characteristics between the continuous jetting and the discontinuous jetting can be made small compared to a case where the drive signal COMb used in detecting the residual vibration signal VR2 is adopted. Each of the waveforms illustrated in FIG. 7 is a waveform for describing the operation or the like of the analysis portion 3 and does not accurately represent a relationship between residual vibration of the vibration plate 14 caused by the continuous jetting and residual vibration of the vibration plate 14 caused by the discontinuous jetting.

As described above, the residual vibration signal VR indicates a waveform corresponding to residual vibration of the detection target jetting portion D, that is, the residual vibration of the vibration plate 14. Specifically, the residual vibration signal VR indicates an amplitude corresponding to the amplitude of the residual vibration of the vibration plate 14, indicates a period corresponding to the period of the residual vibration of the vibration plate 14, and indicates a phase corresponding to the phase of the residual vibration of the vibration plate 14. In FIG. 7, the same number as the number added to the end of the reference numeral of the residual vibration signal VR is added to the end of the reference numeral of the element such as the amplitude of each residual vibration signal VR. For example, an amplitude λA0 indicates an amplitude λA of a first peak of a waveform of the residual vibration signal VR0, an amplitude λA1 indicates the amplitude λA of a first peak of a waveform of the residual vibration signal VR1, and an amplitude λA2 indicates the amplitude λA of a first peak of a waveform of the residual vibration signal VR2.

In the example illustrated in FIG. 7, the analysis portion 3 identifies the amplitude λA of the first peak of the residual vibration signal VR as the amplitude of the first peak of the residual vibration of the vibration plate 14 and identifies an amplitude λB of a second peak of the residual vibration signal VR as an amplitude of a second peak of the residual vibration of the vibration plate 14. Specifically, the analysis portion 3 identifies the amplitude λA0 of the first peak and an amplitude λB0 of a second peak of the residual vibration signal VR0 as the amplitude of the first peak and the amplitude of the second peak of the residual vibration of the vibration plate 14 caused by the continuous jetting, respectively. Similarly, the analysis portion 3 identifies the amplitude λA1 of the first peak and an amplitude λB1 of a second peak of the residual vibration signal VR1 as the amplitude of the first peak and the amplitude of the second peak of the residual vibration of the vibration plate 14 caused by the discontinuous jetting using the first drive signal COMb, respectively. In addition, the analysis portion 3 identifies the amplitude λA2 of the first peak and an amplitude λB2 of a second peak of the residual vibration signal VR2 as the amplitude of the first peak and the amplitude of the second peak of the residual vibration of the vibration plate 14 caused by the discontinuous jetting using the second drive signal COMb, respectively.

A method of identifying the amplitude of the residual vibration signal VR is not particularly limited, and a known method can be adopted. In addition, the analysis portion 3 may identify an amplitude λC0 of a third peak of the residual vibration signal VR0 as an amplitude of a third peak of the residual vibration of the vibration plate 14 caused by the continuous jetting. Similarly, the analysis portion 3 may identify an amplitude λC1 of a third peak of the residual vibration signal VR1 as an amplitude of a third peak of the residual vibration of the vibration plate 14 caused by the discontinuous jetting using the first drive signal COMb. In addition, the analysis portion 3 may identify an amplitude λC2 of a third peak of the residual vibration signal VR2 as the amplitude of a third peak of the residual vibration of the vibration plate 14 caused by the discontinuous jetting using the second drive signal COMb.

In addition, for example, the analysis portion 3 identifies the phase of the residual vibration signal VR as the phase of the residual vibration of the vibration plate 14. In the present embodiment, for example, a case where a time TA from the start of the unit period TU to the first peak of the residual vibration signal VR is identified as a first phase of the residual vibration signal VR is assumed. Further, in the present embodiment, a case where a time TB from the start of the unit period TU to the second peak of the residual vibration signal VR is identified as a second phase of the residual vibration signal VR is assumed. For example, when the periods of the plurality of residual vibration signals VR are regarded the same, a difference between the time TA of one residual vibration signal VR and the time TA of the other residual vibration signal VR can be considered as a shifted amount of the other residual vibration signal VR with respect to the one residual vibration signal VR.

Therefore, for example, the analysis portion 3 identifies times TA0 and TB0 of the residual vibration signal VR0 as a first phase and a second phase of the residual vibration of the vibration plate 14 caused by the continuous jetting, respectively. Similarly, the analysis portion 3 identifies times TA1 and TB1 of the residual vibration signal VR1 as a first phase and a second phase of the residual vibration of the vibration plate 14 caused by the discontinuous jetting using the first drive signal COMb, respectively. In addition, the analysis portion 3 identifies times TA2 and TB2 of the residual vibration signal VR2 as a first phase and a second phase of the residual vibration of the vibration plate 14 caused by the discontinuous jetting using the second drive signal COMb, respectively.

A method of identifying the phase of the residual vibration signal VR is not particularly limited, and a known method can be adopted.

The analysis portion 3 outputs, for example, the residual vibration information Vinf indicating the amplitudes λA and λB of the residual vibration signal VR and the times TA and TB identified as the phases of the residual vibration signal VR to the control unit 4.

The analysis portion 3 may identify, for example, the period of the residual vibration signal VR as the period of the residual vibration of the vibration plate 14. For example, the analysis portion 3 may identify a time from the first peak to the third peak of the residual vibration signal VR0 as the period of the residual vibration of the vibration plate 14 caused by the continuous jetting. Similarly, the analysis portion 3 may identify a time from the first peak to the third peak of the residual vibration signal VR1 as the period of the residual vibration of the vibration plate 14 caused by the discontinuous jetting using the first drive signal COMb. In addition, the analysis portion 3 may identify a time from the first peak to the third peak of the residual vibration signal VR2 as the period of the residual vibration of the vibration plate 14 caused by the discontinuous jetting using the second drive signal COMb. A method of identifying the period of the residual vibration signal VR is not particularly limited, and a known method can be adopted. For example, when the period of the residual vibration signal VR is identified, the analysis portion 3 outputs the residual vibration information Vinf including information indicating the period of the residual vibration signal VR to the control unit 4.

Next, an example of the drive signal COMb used in evaluating variations in jetting characteristics of the nozzle N will be described with reference to FIG. 8.

FIG. 8 is an explanatory diagram for describing an example of the drive signal COMb used in evaluating variations in jetting characteristics of the nozzle N. In the example illustrated in FIG. 8, the residual vibration of the detection target jetting portion D[m] is detected in a third unit period TU3 among the three continuous unit periods TU.

As illustrated in FIG. 8, in the continuous jetting, the drive signal COMa including the vibration pulse PA is supplied to the jetting portion D[m] as the individual drive signal Vin[m] in each of the first unit period TU1 and a second unit period TU2 among the three continuous unit periods TU.

In addition, in the discontinuous jetting, the drive signal COMb including the minute vibration pulse PB is supplied to the jetting portion D[m] as the individual drive signal Vin[m] in the unit period TU1. Then, in the unit period TU2, the drive signal COMa including the vibration pulse PA is supplied to the jetting portion D[m] as the individual drive signal Vin[m].

In FIG. 8, in the unit period TU1, the drive signal COMb supplied to the jetting portion D[m] as the individual drive signal Vin[m], that is, the minute vibration pulse PB will be mainly described. In the example illustrated in FIG. 8, five types of drive signals COMb from a first example to a fifth example are illustrated. In FIG. 8, in order to facilitate understanding of the description, any one of the numbers “1”, “2”, “3”, “4”, and “5” is added to the end of the reference numeral of the minute vibration pulse PB from the first example to the fifth example.

In the first example illustrated in FIG. 8, the drive signal COMb including a minute vibration pulse PB1 is supplied to the jetting portion D[m] as the individual drive signal Vin[m]. The minute vibration pulse PB1 is a pulse having an amplitude λ1 and a pulse width W1 and is applied to the piezoelectric element PZ of the jetting portion D[m] at a timing T1 within the unit period TU1.

In the second example, the drive signal COMb including a minute vibration pulse PB2 is supplied to the jetting portion D[m] as the individual drive signal Vin[m]. The minute vibration pulse PB2 is a pulse having the amplitude A1 and a pulse width W2 and is applied to the piezoelectric element PZ of the jetting portion D[m] at the timing T1 within the unit period TU1. That is, in the second example, the minute vibration pulse PB2 having the pulse width W2 different from the pulse width W1 of the minute vibration pulse PB1 is applied to the piezoelectric element PZ of the jetting portion D[m].

In the third example, the drive signal COMb including a minute vibration pulse PB3 is supplied to the jetting portion D[m] as the individual drive signal Vin[m]. The minute vibration pulse PB3 is a pulse having an amplitude A2 and the pulse width W1 and is applied to the piezoelectric element PZ of the jetting portion D[m] at the timing T1 within the unit period TU1. That is, in the third example, the minute vibration pulse PB3 having the amplitude A2 different from the amplitude A1 of the minute vibration pulse PB1 is applied to the piezoelectric element PZ of the jetting portion D[m].

In the fourth example, the drive signal COMb including a minute vibration pulse PB4 is supplied to the jetting portion D[m] as the individual drive signal Vin[m]. The minute vibration pulse PB4 is a pulse having the amplitude A1 and the pulse width W1 and is applied to the piezoelectric element PZ of the jetting portion D[m] at a timing T2 within the unit period TU1. That is, in the fourth example, the minute vibration pulse PB4 is applied to the piezoelectric element PZ of the jetting portion D[m] at the timing T2 different from the timing T1.

In the fifth example, the drive signal COMb including a minute vibration pulse PB5 is supplied to the jetting portion D[m] as the individual drive signal Vin[m]. The minute vibration pulse PB5 includes two pulses PL1 and PL2 having the amplitude A1 and the pulse width W1. Hereinafter, the pulses PL1 and PL2 will also be referred to as a pulse PL without particularly distinguishing therebetween. In the fifth example, the minute vibration pulse PB5 including the number of pulses PL different from the number of pulses included in the minute vibration pulse PB1 is applied to the piezoelectric element PZ of the jetting portion D[m].

Herein, the minute vibration pulse PB1 is an example of a “first minute vibration pulse”, and each of the minute vibration pulses PB2, PB3, and PB5 is an example of a “second minute vibration pulse”. In addition, the timing T1 is an example of a “first timing”, and the timing T2 is an example of a “second timing”.

The drive signal COMb used in evaluating variations in jetting characteristics of the nozzle N, that is, a candidate for the drive signal COMb is not limited to the example illustrated in FIG. 8. For example, the drive signal COMb may include the minute vibration pulse PB having the pulse width W2 different from the pulse width W1 of the minute vibration pulse PB1 and the amplitude A2 different from the amplitude A1 of the minute vibration pulse PB1. In addition, for example, in the fifth example, one or both of the amplitude A1 and the pulse width W1 may be different in two pulses Pb. In addition, for example, in the fifth example, the minute vibration pulse PB5 may include three or more pulses Pb. In addition, for example, the minute vibration pulse PB included in the drive signal COMb may be a waveform in which the potential of the drive signal COMb changes from the potential VC to a potential lower than the potential VC and then returns to the potential VC.

Next, an operation of the liquid jetting apparatus 100 when evaluating variations in jetting characteristics of the nozzle N will be described with reference to FIG. 9.

FIG. 9 is a flowchart illustrating an example of the operation of the liquid jetting apparatus 100 when evaluating variations in jetting characteristics of the nozzle N. A timing when the operation illustrated in FIG. 9 is performed is not particularly limited, but it is preferable to be performed when the liquid jetting apparatus 100 is used for the first time or when a usage condition of the liquid jetting apparatus 100 is changed due to a change in the type or the like of an ink to be used. The usage condition of the liquid jetting apparatus 100 also includes a usage condition of the liquid jetting head 1.

The operation illustrated in FIG. 9 is performed with respect to each of the plurality of liquid jetting heads 1, for example. In addition, the detection target nozzle N when evaluating variations in jetting characteristics of the nozzle N is the nozzle N representing the M nozzles N. The nozzle N representing the M nozzles N may be one nozzle N of the M nozzles N or may be a plurality of nozzles N. When the nozzle N representing the M nozzles N is the plurality of nozzles N, the operation illustrated in FIG. 9 is performed with respect to each of the plurality of nozzles N. In FIGS. 9 and 10, the operation of the liquid jetting apparatus 100 will be described assuming that the nozzle N representing the M nozzles Nis one nozzle N among the M nozzles N.

The control unit 4 functions as the evaluation control portion 40 in each of steps from step S100 to step S152 illustrated in FIG. 9 and in step S200. The process of step S100 is performed, for example, in a state where an ink used by a user of the liquid jetting apparatus 100 fills the pressure chamber CV. That is, after the ink used by the user fills the pressure chamber CV, the process of step S100 is performed. The processing of filling the pressure chamber CV with the ink may be performed by the evaluation control portion 40 or may be performed by a processing portion other than the evaluation control portion 40. The user is, for example, a user of the liquid jetting apparatus 100. In addition, when a manufacturer and the user of the liquid jetting apparatus 100 are the same, the manufacturer of the liquid jetting apparatus 100 may be considered as the user.

First, in step S100, the evaluation control portion 40 performs the continuous jetting in which jetting driving with the drive signal COMa for jetting the ink from the nozzle N is continuous. For example, the evaluation control portion 40 controls the liquid jetting head 1 such that the piezoelectric element PZ of the detection target jetting portion D is driven by the drive signal COMa in each of the continuous unit periods TU. Accordingly, the jetting driving with the drive signal COMa is continuously performed.

Next, in step S110, the evaluation control portion 40 detects the residual vibration of the detection target jetting portion D immediately after the continuous jetting in step S100 is performed. For example, the evaluation control portion 40 causes the detection circuit 19 to detect the residual vibration from the piezoelectric element PZ of the detection target jetting portion D in the next unit period TU of the two continuous unit periods TU when the jetting driving is performed. Accordingly, the residual vibration of the vibration plate 14 caused by continuously performing the jetting driving is detected by the detection circuit 19. Then, the residual vibration detected by the detection circuit 19 is analyzed by the analysis portion 3. Accordingly, for example, the amplitudes λA0 and λB0 of the residual vibration signal VR0 and the times TA0 and TB0 indicating the phases of the residual vibration signal VR0 are identified as analysis results of the residual vibration of the vibration plate 14 caused by continuously performing the jetting driving. Then, the evaluation control portion 40 acquires the residual vibration information Vinf indicating the analysis results of the residual vibration detected by the detection circuit 19 from the analysis portion 3. The residual vibration detected in step S110 is an example of “first residual vibration”.

Next, in step S120, the evaluation control portion 40 sets a variable i to “1”. The evaluation control portion 40 performs the process of step S120 and then shifts the process to step S130.

In step S130, the evaluation control portion 40 performs the discontinuous jetting using the i-th candidate minute vibration pulse PB of the drive signal COMb. For example, the evaluation control portion 40 controls the liquid jetting head 1 in the first unit period TU of the two continuous unit periods TU such that the piezoelectric element PZ of the detection target jetting portion D is driven with the i-th candidate minute vibration pulse PB of the drive signal COMb. Then, the evaluation control portion 40 controls the liquid jetting head 1 in the second unit period TU of the two continuous unit periods TU described above such that the piezoelectric element PZ of the detection target jetting portion D is driven by the driving signal COMa. Accordingly, the non-jetting driving by the i-th candidate for the drive signal COMb and the jetting driving by the drive signal COMa are continuously performed in this order.

Next, in step S140, the evaluation control portion 40 detects the residual vibration of the detection target jetting portion D immediately after the discontinuous jetting in step S130 is performed. For example, the evaluation control portion 40 causes the detection circuit 19 to detect the residual vibration from the piezoelectric element PZ of the detection target jetting portion D in the next unit period TU of the second unit period TU of the two continuous unit periods TU described in step S130. Accordingly, the residual vibration of the vibration plate 14 caused by continuously performing the non-jetting driving and the jetting driving in this order is detected by the detection circuit 19. Then, the residual vibration detected by the detection circuit 19 is analyzed by the analysis portion 3. Accordingly, for example, amplitudes λAi and λBi of a residual vibration signal VRi and times TAi and TBi indicating phases of the residual vibration signal VRi are identified as analysis results of the residual vibration of the vibration plate 14 caused by continuously performing the non-jetting driving and the jetting driving in this order. The “i” at the end of each of the reference numerals of the residual vibration signal VRi, the amplitudes λAi and λBi, and the times TAi and TBi indicates that the residual vibration signal VR and elements of the residual vibration signal VR correspond to the i-th candidate for the drive signal COMb. The evaluation control portion 40 acquires the residual vibration information Vinf indicating the analysis results of the residual vibration detected by the detection circuit 19 from the analysis portion 3. The residual vibration detected in step S140 is an example of “second residual vibration”.

Next, in step S150, the evaluation control portion 40 determines whether or not the variable i is a final value. The final value of the variable i is, for example, the number of candidates for the drive signal COMb prepared in advance. That is, the evaluation control portion 40 determines whether or not the residual vibration of the vibration plate 14 caused by the discontinuous jetting is detected by all the drive signals COMb prepared in advance as the candidates for the drive signal COMb.

When the result of the determination in step S150 is negative, the evaluation control portion 40 adds “1” to the variable i in step S152 and then returns the process to step S130. On the other hand, when the result of the determination in step S150 is positive, the evaluation control portion 40 shifts the process to step S200.

In step S200, the evaluation control portion 40 performs a comparison process of the residual vibration. For example, the evaluation control portion 40 compares the residual vibration of the vibration plate 14 caused by the continuous jetting detected in step S110 and the residual vibration of the vibration plate 14 caused by the discontinuous jetting detected in step S140 for each candidate for the drive signal COMb. As the process of step S120 is performed, it is determined whether or not variations in the jetting characteristics of the nozzle N occur for each candidate for the drive signal COMb, and the operation illustrated in FIG. 9 is ended.

Next, the comparison process of the residual vibration performed in step S200 will be described with reference to FIG. 10.

FIG. 10 is a flowchart illustrating an example of the comparison process of the residual vibration illustrated in FIG. 9. A series of processes from step S210 to step S272 illustrated in FIG. 10 correspond to the process of step S200 illustrated in FIG. 9. The control unit 4 functions as the evaluation control portion 40 in each of the steps from step S210 to step S272 illustrated in FIG. 10. The process in step S210 is performed when the result of the determination in step S150 illustrated in FIG. 9 is positive.

In the operation illustrated in FIG. 10, the times TA0, TB0, TAi, and TBi and the amplitudes λA0, λB0, λAi, and λBi identified by the series of processes from step S100 to step S152 illustrated in FIG. 9 are used. The time TA0, the time TB0, the amplitude λA0, and the amplitude λB0 respectively indicate the first phase, the second phase, the amplitude of the first peak, and the amplitude of the second peak of the residual vibration of the vibration plate 14 caused by the continuous jetting and are identified by the process of step S110 illustrated in FIG. 9. In addition, the time TAi, the time TBi, the amplitude λAi, and the amplitude λBi respectively indicate the first phase, the second phase, the amplitude of the first peak, and the amplitude of the second peak of the residual vibration of the vibration plate 14 caused by the discontinuous jetting using the i-th candidate for the drive signal COMb. For example, the time TAi, the time TBi, the amplitude λAi, and the amplitude λBi are identified by the process of step S140 illustrated in FIG. 9.

First, in step S210, the evaluation control portion 40 sets the variable i to “1”. The evaluation control portion 40 performs the process of step S210 and then shifts the process to step S220.

In step S220, the evaluation control portion 40 determines whether or not the time TAi is 0.6 times or more and 1.4 times or less the time TA0. A range of 0.6 times or more and 1.4 times or less the time TA0 is an example of a “range based on the phase of the first residual vibration”. That is, the evaluation control portion 40 determines whether or not the first phase of the residual vibration of the vibration plate 14 caused by the discontinuous jetting using the i-th candidate for the drive signal COMb is included in a first phase range identified based on the first phase of the residual vibration of the vibration plate 14 caused by the continuous jetting. The first phase range is not limited to the example described above and may be appropriately set based on data obtained by experiments or the like. In addition, for example, the first phase range may be a range in which a predetermined value is subtracted from or added to the time TA0. However, it is preferable that the determination in step S220 is determination as to “whether or not the time TA0 and the time TAi are values close to one another to some extent”.

When the result of the determination in step S220 is negative, that is, when the first phase of the residual vibration of the vibration plate 14 caused by the discontinuous jetting is not included in the first phase range, the evaluation control portion 40 determines that there are variations in the jetting characteristics of the nozzle N and shifts the process to step S262. In step S262, the evaluation control portion 40 determines that the i-th candidate minute vibration pulse PB of the drive signal COMb is not adopted and then shifts the process to step S270. As described above, the evaluation control portion 40 evaluates the variations in the jetting characteristics of the nozzle N based on the first phase of the residual vibration of the vibration plate 14 caused by the discontinuous jetting using the i-th candidate for the drive signal COMb and the first phase of the residual vibration of the vibration plate 14 caused by the continuous jetting.

On the other hand, when the result of the determination in step S220 is positive, that is, when the first phase of the residual vibration of the vibration plate 14 caused by the discontinuous jetting is included in the first phase range, the evaluation control portion 40 shifts the process to step S230.

In step S230, the evaluation control portion 40 determines whether or not the time TBi is 0.8 times or more and 1.2 times or less the time TB0. A range of 0.8 times or more and 1.2 times or less the time TB0 is another example of the “range based on the phase of the first residual vibration”. That is, the evaluation control portion 40 determines whether or not the second phase of the residual vibration of the vibration plate 14 caused by the discontinuous jetting using the i-th candidate for the drive signal COMb is included in a second phase range identified based on the second phase of the residual vibration of the vibration plate 14 caused by the continuous jetting. The second phase range is not limited to the example described above and may be appropriately set based on data obtained by experiments or the like. In addition, for example, the second phase range may be a range in which a predetermined value is subtracted from or added to the time TB0. However, it is preferable that the determination in step S230 is determination as to “whether or not the time TB0 and the time TBi are values close to one another to some extent”.

When the result of the determination in step S230 is negative, that is, when the second phase of the residual vibration of the vibration plate 14 caused by the discontinuous jetting is not included in the second phase range, the evaluation control portion 40 determines that there are variations in the jetting characteristics of the nozzle N and shifts the process to step S262. As described above, the evaluation control portion 40 evaluates the variations in the jetting characteristics of the nozzle N based on the second phase of the residual vibration of the vibration plate 14 caused by the discontinuous jetting using the i-th candidate for the drive signal COMb and the second phase of the residual vibration of the vibration plate 14 caused by the continuous jetting.

On the other hand, when the result of the determination in step S230 is positive, that is, when the second phase of the residual vibration of the vibration plate 14 caused by the discontinuous jetting is included in the second phase range, the evaluation control portion 40 shifts the process to step S240.

In step S240, the evaluation control portion 40 determines whether or not the amplitude λAi is 0.5 times or more and 1.5 times or less the amplitude λA0. The range of 0.5 times or more and 1.5 times or less the amplitude λA0 is an example of a “first range”. That is, the evaluation control portion 40 determines whether or not the amplitude of the first peak of the residual vibration of the vibration plate 14 caused by the discontinuous jetting using the i-th candidate for the drive signal COMb is included in the first range identified based on the amplitude of the first peak of the residual vibration of the vibration plate 14 caused by the continuous jetting. The first range is not limited to the example described above and may be appropriately set based on data obtained by experiments or the like. In addition, for example, the first range may be a range in which a predetermined value is subtracted from or added to the amplitude λA0. However, it is preferable that the determination in step S240 is determination as to “whether or not the amplitude λA0 and the amplitude λAi are values close to one another to some extent”.

When the result of the determination in step S240 is negative, that is, when the amplitude of the first peak of the residual vibration of the vibration plate 14 caused by the discontinuous jetting is not included in the first range, the evaluation control portion 40 determines that there are variations in the jetting characteristics of the nozzle N and shifts the process to step S262. As described above, the evaluation control portion 40 evaluates the variations in the jetting characteristics of the nozzle N based on the amplitude of the first peak of the residual vibration of the vibration plate 14 caused by the discontinuous jetting using the i-th candidate for the drive signal COMb and the amplitude of the first peak of the residual vibration of the vibration plate 14 caused by the continuous jetting.

On the other hand, when the result of the determination in step S240 is positive, that is, when the amplitude of the first peak of the residual vibration of the vibration plate 14 caused by the discontinuous jetting is included in the first range, the evaluation control portion 40 shifts the process to step S250.

In step S250, the evaluation control portion 40 determines whether or not the amplitude λBi is 0.7 times or more and 1.3 times or less the amplitude λB0. The range of 0.7 times or more and 1.3 times or less the amplitude λB0 is an example of a “second range”. That is, the evaluation control portion 40 determines whether or not the amplitude of the second peak of the residual vibration of the vibration plate 14 caused by the discontinuous jetting using the i-th candidate for the drive signal COMb is included in the second range identified based on the amplitude of the second peak of the residual vibration of the vibration plate 14 caused by the continuous jetting. The second range is not limited to the example described above and may be appropriately set based on data obtained by experiments or the like. In addition, for example, the second range may be a range in which a predetermined value is subtracted from or added to the amplitude λB0. However, it is preferable that the determination in step S250 is determination as to “whether or not the amplitude λB0 and the amplitude λBi are values close to one another to some extent”.

When the result of the determination in step S250 is negative, that is, when the amplitude of the second peak of the residual vibration of the vibration plate 14 caused by the discontinuous jetting is not included in the second range, the evaluation control portion 40 determines that there are variations in the jetting characteristics of the nozzle N and shifts the process to step S262. As described above, the evaluation control portion 40 evaluates the variations in the jetting characteristics of the nozzle N based on the amplitude of the second peak of the residual vibration of the vibration plate 14 caused by the discontinuous jetting using the i-th candidate for the drive signal COMb and the amplitude of the second peak of the residual vibration of the vibration plate 14 caused by the continuous jetting.

On the other hand, when the result of the determination in step S250 is positive, that is, when the amplitude of the second peak of the residual vibration of the vibration plate 14 caused by the discontinuous jetting is included in the second range, the evaluation control portion 40 determines that there is no variation in the jetting characteristics of the nozzle N and shifts the process to step S260.

In step S260, the evaluation control portion 40 determines the i-th candidate minute vibration pulse PB of the drive signal COMb as an adoption candidate. That is, when the waveform of the residual vibration of the vibration plate 14 caused by the discontinuous jetting using the i-th candidate for the drive signal COMb matches or is similar to the waveform of the residual vibration of the vibration plate 14 caused by the continuous jetting, the evaluation control portion 40 determines the i-th candidate for the drive signal COMb as the adoption candidate. The evaluation control portion 40 performs the process of step S260 and then shifts the process to step S270.

In step S270, the evaluation control portion 40 determines whether or not the variable i is a final value. That is, the evaluation control portion 40 determines whether or not the comparison of the residual vibration detected by the series of processes from step S100 to step S152 illustrated in FIG. 9 is ended.

When the result of the determination in step S270 is negative, the evaluation control portion 40 adds “1” to the variable i in step S272 and then returns the process to step S220. On the other hand, when the result of the determination in step S270 is positive, the evaluation control portion 40 ends the operations illustrated in FIGS. 9 and 10.

Herein, in the evaluation of the variations in the jetting characteristics of the nozzle N illustrated in FIG. 10, the first range described above is a range in which a value obtained by multiplying the amplitude λA0 by a first coefficient “0.5” is subtracted from or added to the amplitude λA0. In addition, the second range described above is a range in which a value obtained by multiplying the amplitude λB0 by a second coefficient “0.3” is subtracted from or added to the amplitude λB0. The second coefficient is smaller than the first coefficient. Herein, since the residual vibration is attenuated, among the amplitudes of the plurality of peaks of the residual vibration signal VR, an amplitude of a second half peak tends to be smaller than an amplitude of a first half peak. When the value of actual data obtained as the amplitude of the peak is large, a deviation of a measured value when some measurement error occurs is large compared to a case where the value of the actual data obtained as the amplitude of the peak is small. For this reason, by making the first coefficient larger than the second coefficient and allowing the deviation to be larger in the first half in which the amplitude of the peak is large, the variations in the jetting characteristics of the nozzle N can be accurately evaluated. However, a relationship between the first coefficient and the second coefficient is not limited to the example described above. For example, the first coefficient and the second coefficient may have the same value as one another.

The operation of the liquid jetting apparatus 100 when evaluating the variations in the jetting characteristics of the nozzle N is not limited to the examples illustrated in FIGS. 9 and 10. For example, the process of step S120 illustrated in FIG. 9 may be performed before the process of step S100.

In addition, for example, one, two, or three of the process of step S220, the process of step S230, the process of step S240, and the process of step S250 may be omitted. Alternatively, the evaluation control portion 40 may evaluate the variations in the jetting characteristics of the nozzle N based on the period of the residual vibration of the vibration plate 14 caused by the discontinuous jetting and the period of the residual vibration of the vibration plate 14 caused by the continuous jetting. When the process of evaluating the variations in the jetting characteristics of the nozzle N based on the period of the residual vibration is performed, some or all of the process of step S220, the process of step S230, the process of step S240, and the process of step S250 may be omitted.

In addition, for example, the evaluation control portion 40 may determine the waveform of the drive signal COMb, that is, the waveform of the minute vibration pulse PB based on the result of evaluating the variations in the jetting characteristics of the nozzle N. For example, in the process illustrated in FIG. 10, the evaluation control portion 40 may adopt a candidate for the drive signal COMb, which is determined as the adoption candidate, as the drive signal COMb to be actually used in the printing process. That is, the evaluation control portion 40 may determine the waveform of the drive signal COMb, that is, the waveform of the minute vibration pulse PB, based on the residual vibration of the vibration plate 14 caused by the continuous jetting and the residual vibration of the vibration plate 14 caused by the discontinuous jetting. In addition, for example, when there are a plurality of candidates for the drive signal COMb determined as the adoption candidates, the evaluation control portion 40 may adopt one of the plurality of adoption candidates as the drive signal COMb to be actually used in the printing process. Specifically, the evaluation control portion 40 may adopt, as the drive signal COMb, an adoption candidate in which the waveform of the residual vibration of the vibration plate 14 caused by the discontinuous jetting matches or is most similar to the waveform of the residual vibration of the vibration plate 14 caused by the continuous jetting, among the plurality of adoption candidates. As described above, in the present embodiment, by determining the waveform of the drive signal COMb based on the evaluation results of the variations in the jetting characteristics of the nozzle N, occurrence of the variations in the jetting characteristics between the continuous jetting and the discontinuous jetting can be easily suppressed.

As described above, in the present embodiment, the liquid jetting apparatus 100 includes the liquid jetting head 1 including the nozzle N that jets an ink, the piezoelectric element PZ that corresponds to the nozzle N, the vibration plate 14 that vibrates by driving the piezoelectric element PZ, and the detection circuit 19 that detects the residual vibration of the vibration plate 14 caused by the driving of the piezoelectric element PZ, and the evaluation control portion 40. The evaluation control portion 40 can perform non-jetting driving in which the piezoelectric element PZ is driven with the minute vibration pulse PB that does not jet an ink from the nozzle N and jetting driving in which the piezoelectric element PZ is driven with the vibration pulse PA that generates vibration at the vibration plate 14 larger than the vibration of the vibration plate 14 caused by the non-jetting driving, causes the detection circuit 19 to detect the residual vibration caused by continuously performing the jetting driving as the first residual vibration, causes the detection circuit 19 to detect the residual vibration caused by continuously driving the piezoelectric element PZ in the order of the non-jetting driving and the jetting driving as the second residual vibration, and evaluates variations in the jetting characteristics of the nozzle N between a case where the jetting driving is continuous and a case where the jetting driving is not continuous based on the first residual vibration and the second residual vibration detected by the detection circuit 19. In addition, the evaluation control portion 40 may determine the waveform of the minute vibration pulse PB based on the first residual vibration and the second residual vibration detected by the detection circuit 19.

As described above, in the present embodiment, the evaluation control portion 40 evaluates the variations in the jetting characteristics of the nozzle N based on the first residual vibration caused by continuously performing the jetting driving and the second residual vibration caused by continuously driving the piezoelectric element PZ in the order of the non-jetting driving and the jetting driving. Therefore, in the present embodiment, the variations in the jetting characteristics of the nozzle N between a case where the jetting driving is continuous and a case where the jetting driving is not continuous can be appropriately and easily evaluated. In addition, in the present embodiment, the evaluation control portion 40 determines the waveform of the minute vibration pulse PB based on the first residual vibration and the second residual vibration. Thus, the waveform of the drive signal COMb for driving the piezoelectric element PZ such that an ink is not jetted from the nozzle N can be appropriately and easily determined. For example, in the present embodiment, the evaluation control portion 40 determines the waveform of the drive signal COMb based on the evaluation results of the variations in the jetting characteristics of the nozzle N. Thus, the waveform of the drive signal COMb for not jetting the ink from the nozzle N can be appropriately and easily determined.

In addition, in the present embodiment, the evaluation control portion 40 may evaluate the variations in the jetting characteristics of the nozzle N based on the phase of the first residual vibration and the phase of the second residual vibration. Also in the present aspect, the variations in the jetting characteristics of the nozzle N can be appropriately and easily evaluated.

In addition, in the present embodiment, the evaluation control portion 40 may determine that the jetting characteristics of the nozzle N vary when the phase of the second residual vibration is not included in the range based on the phase of the first residual vibration. Also in the present aspect, the variations in the jetting characteristics of the nozzle N can be appropriately and easily evaluated. In addition, in the present aspect, for example, by not adopting the minute vibration pulse PB determined to have the variations in the jetting characteristics of the nozzle N as the minute vibration pulse PB of the actual drive signal COMb, the waveform of the drive signal COMb can be appropriately and easily determined.

In addition, in the present embodiment, the evaluation control portion 40 may evaluate the variations in the jetting characteristics of the nozzle N based on the amplitude of the first residual vibration and the amplitude of the second residual vibration. Also in the present aspect, the variations in the jetting characteristics of the nozzle N can be appropriately and easily evaluated.

In addition, in the present embodiment, the evaluation control portion 40 may determine that the jetting characteristics of the nozzle N vary when the amplitude of the first peak of the second residual vibration is not included in the first range based on the amplitude of the first peak of the first residual vibration. Also in the present aspect, the variations in the jetting characteristics of the nozzle N can be appropriately and easily evaluated. In addition, also in the present aspect, for example, by not adopting the minute vibration pulse PB determined to have the variations in the jetting characteristics of the nozzle N as the minute vibration pulse PB of the actual drive signal COMb, the waveform of the drive signal COMb can be appropriately and easily determined.

In addition, in the present embodiment, the evaluation control portion 40 may determine that the jetting characteristics of the nozzle N vary when the amplitude of the second peak of the second residual vibration is not included in the second range based on the amplitude of the second peak of the first residual vibration. Also in the present aspect, the variations in the jetting characteristics of the nozzle N can be appropriately and easily evaluated.

In addition, in the present embodiment, the first range may be a range in which a value obtained by multiplying the amplitude of the first peak of the first residual vibration by the first coefficient is subtracted from or added to the amplitude of the first peak of the first residual vibration. The second range may be a range in which a value obtained by multiplying the amplitude of the second peak of the first residual vibration by the second coefficient is subtracted from or added to the amplitude of the second peak of the first residual vibration. The second coefficient is smaller than the first coefficient. Also in the present aspect, the variations in the jetting characteristics of the nozzle N can be appropriately and easily evaluated. In addition, in the present aspect, since the second coefficient is smaller than the first coefficient, the presence or absence of the variations in the jetting characteristics of the nozzle N can be accurately evaluated.

In addition, in the present embodiment, the evaluation control portion 40 may evaluate the variations in the jetting characteristics of the nozzle N with the minute vibration pulse PB1 as the minute vibration pulse PB and may further evaluate the variations in the jetting characteristics of the nozzle N with the minute vibration pulse PB2 having the pulse width W2 different from the pulse width W1 of the minute vibration pulse PB1 as the minute vibration pulse PB. Also in the present aspect, the variations in the jetting characteristics of the nozzle N can be appropriately and easily evaluated. In addition, in the present aspect, whether it is better to adopt the minute vibration pulse PB1 as the minute vibration pulse PB or to adopt the minute vibration pulse PB2 as the minute vibration pulse PB can be easily determined.

In addition, in the present embodiment, the evaluation control portion 40 may evaluate the variations in the jetting characteristics of the nozzle N with the minute vibration pulse PB1 as the minute vibration pulse PB and may further evaluate the variations in the jetting characteristics of the nozzle N with the minute vibration pulse PB3 having the amplitude A2 different from the amplitude A1 of the minute vibration pulse PB1 as the minute vibration pulse PB. Also in the present aspect, the variations in the jetting characteristics of the nozzle N can be appropriately and easily evaluated. In addition, in the present aspect, whether it is better to adopt the minute vibration pulse PB1 as the minute vibration pulse PB or to adopt the minute vibration pulse PB3 as the minute vibration pulse PB can be easily determined.

In addition, in the present embodiment, the evaluation control portion 40 may perform the non-jetting driving by applying the minute vibration pulse PB to the piezoelectric element PZ at the timing T1 within the unit period TU for driving the piezoelectric element PZ to evaluate the variations in the jetting characteristics of the nozzle N and further perform the non-jetting driving by applying the minute vibration pulse PB to the piezoelectric element PZ at the timing T2 different from the timing T1 within the unit period TU to evaluate the variations in the jetting characteristics of the nozzle N. Also in the present aspect, the variations in the jetting characteristics of the nozzle N can be appropriately and easily evaluated. In addition, in the present aspect, whether it is better to apply the minute vibration pulse PB to the piezoelectric element PZ at the timing T1 or to apply the minute vibration pulse PB to the piezoelectric element PZ at the timing T2 can be easily determined.

In addition, in the present embodiment, the evaluation control portion 40 may evaluate the variations in the jetting characteristics of the nozzle N with the minute vibration pulse PB1 including at least one pulse as the minute vibration pulse PB and may further evaluate the variations in the jetting characteristics of the nozzle N with the minute vibration pulse PB5 including the number of pulses Pb different from the number of pulses included in the minute vibration pulse PB1 as the minute vibration pulse PB. Also in the present aspect, the variations in the jetting characteristics of the nozzle N can be appropriately and easily evaluated. In addition, in the present aspect, whether it is better to adopt the minute vibration pulse PB1 as the minute vibration pulse PB or to adopt the minute vibration pulse PB5 as the minute vibration pulse PB can be easily determined.

In addition, in the present embodiment, the vibration pulse PA is a pulse for jetting an ink from the nozzle N. Also in the present aspect, the variations in the jetting characteristics of the nozzle N can be appropriately and easily evaluated. In addition, in the present aspect, since the vibration pulse PA is a pulse for jetting the ink from the nozzle N, the variations in the jetting characteristics of the nozzle N can be evaluated under the condition close to the actual jetting condition. As a result, in the present aspect, the presence or absence of the variations in the jetting characteristics of the nozzle N can be accurately evaluated.

### 2. Modification Example

Each embodiment above can be modified in various manners. A specific aspect of the modification will be described below. Two or more aspects selected in any manner from the following examples can be appropriately combined with one another within a range not inconsistent with one another. In modification examples to be described below, elements having the same effects and functions as those of the embodiment will be given the reference numerals used in the description above, and each detailed description thereof will be appropriately omitted.

### First Modification Example

In the embodiment described above, a case where the residual vibration caused by continuously performing the jetting driving is detected as the first residual vibration is given as an example, but the present disclosure is not limited to such an aspect. For example, the evaluation control portion 40 may cause the detection circuit 19 to detect the residual vibration caused by continuously performing vibration driving in which the piezoelectric element PZ is driven with a vibration pulse at which an ink is not jetted from the nozzle N as the first residual vibration. The vibration pulse described above is a pulse that causes the vibration plate 14 to generate vibration larger than the vibration of the vibration plate 14 caused by the non-jetting driving in which the piezoelectric element PZ is driven with the minute vibration pulse PB. Also in the present modification example, the same effect as the effect of the embodiment described above can be obtained. In addition, in the present modification example, since the ink is not jetted from the nozzle N when evaluating the variations in the jetting characteristic of the nozzle N, the amount of ink consumed in evaluating the variations in the jetting characteristic of the nozzle N can be reduced.

### Second Modification Example

In the embodiment described above, a case where the variations in the jetting characteristics of the nozzle N are evaluated based on the first residual vibration and the second residual vibration detected by the detection circuit 19 is given as an example, but the present disclosure is not limited to such an aspect.

For example, in the present modification example, the evaluation control portion 40 causes the detection circuit 19 to detect the residual vibration caused by performing the jetting driving for three continuous times as the first residual vibration. Specifically, for example, in the continuous jetting illustrated in FIG. 8, the evaluation control portion 40 supplies the drive signal COMa including the vibration pulse PA to the jetting portion D[m] as the individual drive signal Vin[m] in the unit period TU before one unit period TU1. Accordingly, in the unit period TU3 illustrated in FIG. 8, the residual vibration caused by performing the jetting driving for the three continuous times is detected as the first residual vibration.

In addition, the evaluation control portion 40 causes the detection circuit 19 to detect, as the second residual vibration, the residual vibration caused by continuously driving the piezoelectric element PZ in the order of the non-jetting driving, the non-jetting driving, and the jetting driving. Specifically, for example, in the discontinuous jetting illustrated in FIG. 8, the evaluation control portion 40 supplies the drive signal COMb including the minute vibration pulse PB to the jetting portion D[m] as the individual drive signal Vin[m] in the unit period TU before one unit period TU1. Accordingly, in the unit period TU3 illustrated in FIG. 8, the residual vibration caused by continuously performing the non-jetting driving, the non-jetting driving, and the jetting driving in this order is detected as the second residual vibration.

In addition, the evaluation control portion 40 causes the detection circuit 19 to detect, as third residual vibration, the residual vibration caused by continuously driving the piezoelectric element PZ in the order of the non-jetting driving, the jetting driving, and the jetting driving. Specifically, for example, in the continuous jetting illustrated in FIG. 8, the evaluation control portion 40 supplies the drive signal COMb including the minute vibration pulse PB to the jetting portion D[m] as the individual drive signal Vin[m] in the unit period TU before one unit period TU1. Accordingly, in the unit period TU3 illustrated in FIG. 8, the residual vibration caused by continuously performing the non-jetting driving, the jetting driving, and the jetting driving in this order is detected as the third residual vibration.

Then, the evaluation control portion 40 evaluates the variations in the jetting characteristics of the nozzle N based on the first residual vibration, the second residual vibration, and the third residual vibration detected by the detection circuit 19. Also in the present modification example, as in the first modification example described above, the vibration driving in which an ink is not jetted from the nozzle N may be performed instead of the jetting driving.

As described above, also in the present modification example, the same effects as the effects of the embodiment and modification examples described above can be obtained.

### Third Modification Example

In the embodiment described above, the drive signal COM for detecting a jetting abnormality of the nozzle N may be supplied from the drive signal generation unit 2 to the liquid jetting head 1.

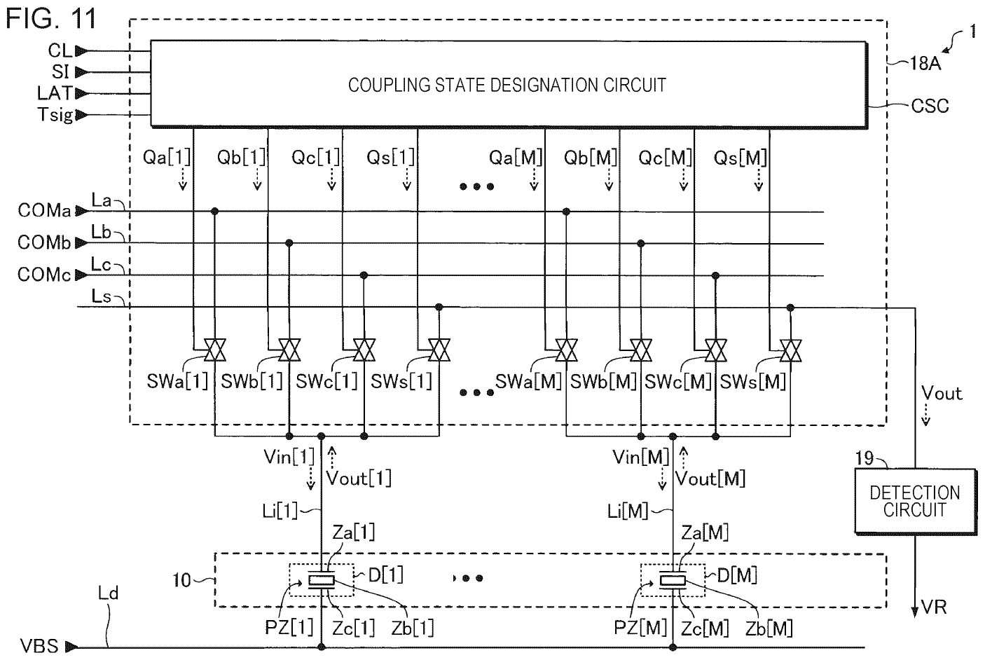

FIG. 11 is a block diagram illustrating an example of a configuration of the liquid jetting head 1 according to a third modification example. The liquid jetting head 1 illustrated in FIG. 11 is the same as the liquid jetting head 1 illustrated in FIG. 5 except that a drive signal COMc for detecting a jetting abnormality of the nozzle N is supplied from the drive signal generation unit 2. Specifically, the liquid jetting head 1 illustrated in FIG. 11 is the same as the liquid jetting head 1 illustrated in FIG. 5 except that the liquid jetting head 1 illustrated in FIG. 11 includes a switching circuit 18A instead of the switching circuit 18 illustrated in FIG. 5.

The switching circuit 18A is the same as the switching circuit 18 except that wiring Lc to which the drive signal COMc is supplied from the drive signal generation unit 2 and M switches SWc[1] to SWb[M] corresponding to the M jetting portions D[1] to D[M] are added to the switching circuit 18 illustrated in FIG. 5 on a one-to-one basis. However, the coupling state designation circuit CSC generates the coupling state designation signals Qa[m], Qb[m], Qc[m], and Qs[m] based on at least one signal of the print signal SI, the latch signal LAT, and a period defining signal Tsig supplied from the control unit 4.

The switch SWc[m] switches between conduction and non-conduction between the wiring Lc and the individual electrode Za[m] of the piezoelectric element PZ[m] provided in the jetting portion D[m] based on the coupling state designation signal Qc[m]. That is, the switch SWc[m] switches between conduction and non-conduction between the wiring Lc and the wiring Li[m] coupled to the individual electrode Za[m] based on the coupling state designation signal Qc[m]. In the present modification example, the switch SWc[m] is turned on when the coupling state designation signal Qc[m] is at a high level and is turned off when the coupling state designation signal Qc[m] is at a low level. When the switch SWc[m] is turned on, the drive signal COMc supplied to the wiring Lc is supplied to the individual electrode Za[m] of the jetting portion D[m] as the individual drive signal Vin[m] via the wiring Li[m].

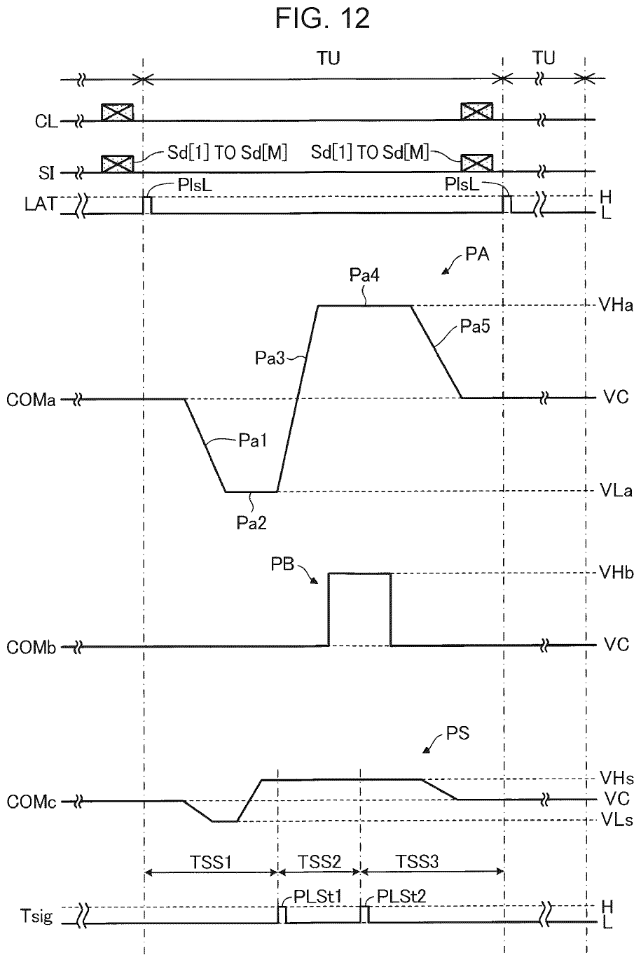

Next, an operation of the liquid jetting apparatus 100 according to the third modification example will be described with reference to FIG. 12.

FIG. 12 is a timing chart illustrating an example of the operation of the liquid jetting apparatus 100 according to the third modification example. The operation of the coupling state designation circuit CSC or the like in a case where the driving aspect of the jetting portion D that forms a dot, the jetting portion D that does not form a dot, and the detection target jetting portion D when evaluating the variations in the jetting characteristics of the nozzle Nis designated by the individual designation signal Sd[m] is the same as the operation illustrated in FIG. 6. For this reason, the operation of the coupling state designation circuit CSC or the like when the driving aspect of the detection target jetting portion D having a jetting abnormality of the nozzle N is designated by the individual designation signal Sd[m] will be described in FIG. 12.

For example, the drive signal generation unit 2 outputs the drive signal COMc having a pulse PS. The pulse PS is a waveform in which the potential of the drive signal COMc changes from the potential VC to a potential VLs lower than the potential VC and a potential VHs higher than the potential VC and then returns to the potential VC. In the present modification example, the pulse PS is determined such that a potential difference between the potential VHs, which is the highest potential of the pulse PS, and the potential VLs, which is the lowest potential, is smaller than a potential difference between the potential VHa, which is the highest potential of the vibration pulse PA, and the potential VLa, which is the lowest potential. Specifically, when the drive signal COMc having the pulse PS is supplied to the jetting portion D[m], a waveform of the pulse PS is defined to drive the jetting portion D[m] to the extent that an ink is not jetted from the jetting portion D[m]. The pulse PS has the potential at the start and the end set to the potential VC, as described above.

In addition, the control unit 4 outputs the period designation signal Tsig having a pulse PLSt1 and a pulse PLSt2. Accordingly, the control unit 4 divides the unit period TU into a control period TSS1 from a start of the pulse PlsL to a start of the pulse PLSt1, a control period TSS2 from the start of the pulse PLSt1 to a start of the pulse PLSt2, and a control period TSS3 from the start of the pulse PLSt2 to a start of the next pulse PlsL.

Then, for example, when the individual designation signal Sd[m] designates the jetting portion D[m] as the detection target jetting portion D having a jetting abnormality, the coupling state designation circuit CSC sets the coupling state designation signals Qa[m] and Qb[m] to a low level in the unit period TU. In addition, the coupling state designation circuit CSC sets the coupling state designation signal Qc[m] to a high level in the control periods TSS1 and TSS3 and to a low level in the control period TSS2, respectively. In addition, the coupling state designation circuit CSC sets the coupling state designation signal Qs[m] to a low level in the control periods TSS1 and TSS3 and to a high level in the control period TSS2, respectively.

In this case, the piezoelectric element PZ[m] included in the detection target jetting portion D[m] having the jetting abnormality is driven with the pulse PS of the drive signal COMc in the control period TSS1. Specifically, the piezoelectric element PZ[m] is displaced by the pulse PS of the drive signal COMc in the control period TSS1. As a result, vibration is generated in the detection target jetting portion D[m]. The vibration generated in the control period TSS1 also remains in the control period TSS2. Then, in the control period TSS2, the potential of the individual electrode Za[m] of the piezoelectric element PZ[m] included in the detection target jetting portion D[m] changes according to the residual vibration generated in the jetting portion D[m]. That is, in the control period TSS2, the potential of the individual electrode Za of the piezoelectric element PZ included in the detection target jetting portion D becomes a potential corresponding to an electromotive force of the piezoelectric element PZ caused by the residual vibration generated in the detection target jetting portion D. The potential of the individual electrode Za is detected as the detection signal Vout in the control period TSS2.

A case where the detection signal Vout indicating the residual vibration of the detection target jetting portion D having the jetting abnormality is generated during the printing process period is illustrated in FIG. 12, but the detection signal Vout may be generated in a period different from the printing process period. That is, the process of detecting the residual vibration of the detection target jetting portion D having the jetting abnormality may be performed in the period different from the printing process period.

As described above, also in the present modification example, the same effect as that of the embodiment described above can be obtained. In addition, in the present modification example, the jetting abnormality of the nozzle N can be detected based on the residual vibration detected using the drive signal COMc.

### Fourth Modification Example

In the embodiment and modification examples described above, waveform information indicating a candidate for the drive signal COMb may be stored in advance in a storage unit (not illustrated) or the like of the liquid jetting head 1 at a time point when the head manufacturer manufactures the liquid jetting head 1. Alternatively, the waveform information indicating a candidate for the drive signal COMb may be stored in the storage unit 5 or the like from the head manufacturer via a network (not illustrated) after shipment of the liquid jetting head 1. For example, the waveform information indicating a candidate for the drive signal COMb prepared by the head manufacturer is read from the storage unit 5 or the like in which the waveform information indicating a candidate for the drive signal COMb is stored when the operation illustrated in FIG. 9 is performed.

As described above, also in the present modification example, the same effect as that of the embodiment described above can be obtained.

### Fifth Modification Example

A case where the control unit 4 performs analysis or the like of the residual vibration detected by the detection circuit 19 is given as an example in the embodiment and modification examples described above, but the present disclosure is not limited to such an aspect. For example, the analysis or the like of the residual vibration detected by the detection circuit 19 may be performed by a control unit such as a CPU of an external server managed by the head manufacturer. In the present modification example, the liquid jetting apparatus 100 has a communication unit that can communicate with the external server managed by the head manufacturer. In addition, for example, the control unit 4 transmits residual vibration data indicating the residual vibration detected by the detection circuit 19 to the external server managed by the head manufacturer via the communication unit. The control unit included in the external server analyzes the residual vibration data transmitted from the liquid jetting apparatus 100. Specifically, for example, the control unit included in the external server identifies the phase and the amplitude of the residual vibration of the vibration plate 14 caused by the continuous jetting and identifies the phase and the amplitude of the residual vibration of the vibration plate 14 caused by the discontinuous jetting. Then, the control unit included in the external server compares the residual vibration of the vibration plate 14 caused by the continuous jetting with the residual vibration of the vibration plate 14 caused by the discontinuous jetting based on the identifying results. The control unit included in the external server determines whether or not there are variations in the jetting characteristics of the nozzle N based on comparison results between the residual vibration of the vibration plate 14 caused by the continuous jetting and the residual vibration of the vibration plate 14 caused by the discontinuous jetting. Then, the control unit included in the external server may transmit the analysis results indicating the presence or absence of the variations in the jetting characteristics of the nozzle N to the liquid jetting apparatus 100. Alternatively, the control unit included in the external server may identify which drive signal COMb is to be used in order to suppress occurrence of the variations in the jetting characteristics of the nozzle N based on the comparison results between the residual vibration of the vibration plate 14 caused by the continuous jetting and the residual vibration of the vibration plate 14 caused by the discontinuous jetting. Then, the control unit included in the external server may transmit the information indicating the identifying results to the liquid jetting apparatus 100.

As described above, also in the present modification example, the same effect as that of the embodiment described above can be obtained.

### Sixth Modification Example

A case where the piezoelectric body Zb is displaced in the Z1 direction by changing the potential of the individual drive signal Vin[m] from a low potential to a high potential is given as an example in the embodiment and modification examples described above, but the present disclosure is not limited to such an aspect. For example, the piezoelectric body Zb that is displaced in the Z1 direction by changing the potential of the individual drive signal Vin[m] from the high potential to the low potential may be used. In this case, for example, the potential of the drive signal COM changes from the low potential to the high potential in a portion corresponding to the expansion element and changes from the high potential to the low potential in a portion corresponding to the contraction element. Also in the present modification example, the same effects as the effects of the embodiment and modification examples described above can be obtained.

### Seventh Modification Example

A case where one piezoelectric element PZ, one pressure chamber CV, and one nozzle N are provided with respect to one jetting portion D is given as an example in the embodiment and modification examples described above, but the present disclosure is not limited to such an aspect. For example, one jetting portion D may have two piezoelectric elements PZ, two pressure chambers CV, and one nozzle N. As described above, also in the present modification example, the same effects as the effects of the embodiment and modification examples described above can be obtained.

### Eighth Modification Example

The liquid jetting apparatus 100 using a serial method in which the carriage 91 on which the liquid jetting head 1 is mounted is reciprocated in the X-axis direction is given as an example in the embodiment and modification examples described above, but the present disclosure is not limited to such an aspect. For example, the liquid jetting apparatus 100 may be a liquid jetting apparatus using a line method in which the plurality of nozzles N are distributed over an entire width of the medium PP. As described above, also in the present modification example, the same effects as the effects of the embodiment and modification examples described above can be obtained.

### Ninth Modification Example

The liquid jetting apparatus 100 described in the embodiment and modification examples described above can be adopted in various types of devices such as a facsimile machine and a copying machine, in addition to a device dedicated to printing. Moreover, the application of the liquid jetting apparatus of the present disclosure is not limited to printing. For example, a liquid jetting apparatus that jets a solution of a coloring material is used as a manufacturing device that forms a color filter of a liquid crystal display device. In addition, a liquid jetting apparatus that jets a solution of a conductive material is used as a manufacturing device that forms wiring or an electrode of a wiring substrate. As described above, also in the present modification example, the same effects as the effects of the embodiment and modification examples described above can be obtained.

### 3. Appendixes

From the embodiment described above, for example, the following configuration can be ascertained.

There is provided a liquid jetting apparatus according to aspect 1, which is a preferred aspect, including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element and a control portion, in which the control portion is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causes the detection portion to detect, as first residual vibration, the residual vibration caused by continuously performing the vibration driving, causes the detection portion to detect, as second residual vibration, the residual vibration caused by continuously driving the piezoelectric element in order of the minute vibration driving and the vibration driving, and evaluates a variation in a jetting characteristic of the nozzle between a case where the vibration driving is continuous and a case where the vibration driving is not continuous based on the first residual vibration and the second residual vibration detected by the detection portion.

According to aspect 1, the variation in the jetting characteristic of the nozzle can be appropriately and easily evaluated.

In the liquid jetting apparatus according to aspect 2, which is a specific example of aspect 1, the control portion evaluates the variation in the jetting characteristic of the nozzle based on a phase of the first residual vibration and a phase of the second residual vibration.

Also in aspect 2, the variation in the jetting characteristic of the nozzle can be appropriately and easily evaluated.

In the liquid jetting apparatus according to aspect 3, which is a specific example of aspect 2, the control portion determines that the jetting characteristic of the nozzle varies when the phase of the second residual vibration is not included in a range based on the phase of the first residual vibration.

Also in aspect 3, the variation in the jetting characteristic of the nozzle can be appropriately and easily evaluated.

In the liquid jetting apparatus according to aspect 4, which is a specific example of any one of aspects 1 to 3, the control portion evaluates the variation in the jetting characteristic of the nozzle based on an amplitude of the first residual vibration and an amplitude of the second residual vibration.

Also in aspect 4, the variation in the jetting characteristic of the nozzle can be appropriately and easily evaluated.

In the liquid jetting apparatus according to aspect 5, which is a specific example of aspect 4, the control portion determines that the jetting characteristic of the nozzle varies when an amplitude of a first peak of the second residual vibration is not included in a first range based on an amplitude of a first peak of the first residual vibration.

Also in aspect 5, the variation in the jetting characteristic of the nozzle can be appropriately and easily evaluated.

In the liquid jetting apparatus according to aspect 6, which is a specific example of aspect 5, the control portion determines that the jetting characteristic of the nozzle varies when an amplitude of a second peak of the second residual vibration is not included in a second range based on an amplitude of a second peak of the first residual vibration.

Also in aspect 6, the variation in the jetting characteristic of the nozzle can be appropriately and easily evaluated.

In the liquid jetting apparatus according to aspect 7, which is a specific example of aspect 6, the first range is a range in which a value obtained by multiplying the amplitude of the first peak of the first residual vibration by a first coefficient is subtracted from or added to the amplitude of the first peak of the first residual vibration, the second range is a range in which a value obtained by multiplying the amplitude of the second peak of the first residual vibration by a second coefficient is subtracted from or added to the amplitude of the second peak of the first residual vibration, and the second coefficient is smaller than the first coefficient.

Also in aspect 7, the variation in the jetting characteristic of the nozzle can be appropriately and easily evaluated. In addition, in the present aspect, since the second coefficient is smaller than the first coefficient, the presence or absence of the variation in the jetting characteristic of the nozzle can be accurately evaluated.

In the liquid jetting apparatus according to aspect 8, which is a specific example of any one of aspects 1 to 7, the control portion evaluates the variation in the jetting characteristic of the nozzle with a first minute vibration pulse as the minute vibration pulse, and further evaluates the variation in the jetting characteristic of the nozzle with a second minute vibration pulse having a pulse width different from a pulse width of the first minute vibration pulse as the minute vibration pulse.

Also in aspect 8, the variations in the jetting characteristics of the nozzle can be appropriately and easily evaluated. In addition, in the present aspect, whether it is better to adopt the first minute vibration pulse as the minute vibration pulse or to adopt the second minute vibration pulse as the minute vibration pulse can be easily determined.

In the liquid jetting apparatus according to aspect 9, which is a specific example of any one of aspects 1 to 8, the control portion evaluates the variation in the jetting characteristic of the nozzle with a first minute vibration pulse as the minute vibration pulse, and further evaluates the variation in the jetting characteristic of the nozzle with a third minute vibration pulse having an amplitude different from an amplitude of the first minute vibration pulse as the minute vibration pulse.

Also in aspect 9, the variation in the jetting characteristic of the nozzle can be appropriately and easily evaluated. In addition, in the present aspect, whether it is better to adopt the first minute vibration pulse as the minute vibration pulse or to adopt the third minute vibration pulse as the minute vibration pulse can be easily determined.

In the liquid jetting apparatus according to aspect 10, which is a specific example of any one of aspects 1 to 9, the control portion performs the minute vibration driving by applying the minute vibration pulse to the piezoelectric element at a first timing within a unit period for driving the piezoelectric element and evaluates the variation in the jetting characteristic of the nozzle, and further performs the minute vibration driving by applying the minute vibration pulse to the piezoelectric element at a second timing different from the first timing within the unit period and evaluates the variation in the jetting characteristic of the nozzle.

Also in aspect 10, the variation in the jetting characteristic of the nozzle can be appropriately and easily evaluated. In addition, in the present aspect, whether it is better to apply the minute vibration pulse to the piezoelectric element at the first timing or to apply the minute vibration pulse to the piezoelectric element at the second timing can be easily determined.

In the liquid jetting apparatus according to aspect 11, which is a specific example of any one of aspects 1 to 10, the control portion evaluates the variation in the jetting characteristic of the nozzle with a fourth minute vibration pulse including at least one pulse as the minute vibration pulse, and further evaluates the variation in the jetting characteristic of the nozzle with a fifth minute vibration pulse including the number of pulses different from the number of pulses included in the fourth minute vibration pulse as the minute vibration pulse.

Also in aspect 11, the variation in the jetting characteristic of the nozzle can be appropriately and easily evaluated. In addition, in the present aspect, whether it is better to adopt the fourth minute vibration pulse as the minute vibration pulse or to adopt the fifth minute vibration pulse as the minute vibration pulse can be easily determined.

In the liquid jetting apparatus according to aspect 12, which is a specific example of any one of aspects 1 to 11, the control portion causes the detection portion to detect the residual vibration caused by continuously performing the vibration driving for three times as the first residual vibration, causes the detection portion to detect, as the second residual vibration, the residual vibration caused by continuously driving the piezoelectric element in order of the minute vibration driving, the minute vibration driving, and the vibration driving, causes the detection portion to detect, as third residual vibration, the residual vibration caused by continuously driving the piezoelectric element in order of the minute vibration driving, the vibration driving, and the vibration driving, and evaluates the variation in the jetting characteristic of the nozzle based on the first residual vibration, the second residual vibration, and the third residual vibration detected by the detection portion.

Also in aspect 12, the variation in the jetting characteristic of the nozzle can be appropriately and easily evaluated.

In the liquid jetting apparatus according to aspect 13, which is a specific example of any one of aspects 1 to 12, the vibration pulse is a pulse for jetting the liquid from the nozzle.

Also in aspect 13, the variation in the jetting characteristic of the nozzle can be appropriately and easily evaluated. In addition, in the present aspect, since the variation in the jetting characteristic of the nozzle under a condition close to an actual jetting condition can be evaluated, the presence or absence of the variation in the jetting characteristic of the nozzle can be accurately evaluated.

In addition, there is provided a liquid jetting apparatus according to aspect 14, which is another preferred aspect, including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element and a control portion, in which the control portion is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causes the detection portion to detect, as first residual vibration, the residual vibration caused by continuously performing the vibration driving, causes the detection portion to detect, as second residual vibration, the residual vibration caused by continuously driving the piezoelectric element in order of the minute vibration driving and the vibration driving, and determines a waveform of the minute vibration pulse based on the first residual vibration and the second residual vibration detected by the detection portion.

According to aspect 14, the waveform of the minute vibration pulse for driving the piezoelectric element such that the liquid is not jetted from the nozzle can be appropriately and easily determined.

In addition, there is provided a control method of a liquid jetting apparatus according to aspect 15, which is a preferred aspect, including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element, the control method including performing minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causing the detection portion to detect, as first residual vibration, the residual vibration caused by continuously performing the vibration driving, causing the detection portion to detect, as second residual vibration, the residual vibration caused by continuously driving the piezoelectric element in order of the minute vibration driving and the vibration driving, and evaluating a variation in a jetting characteristic of the nozzle between a case where the vibration driving is continuous and a case where the vibration driving is not continuous based on the first residual vibration and the second residual vibration detected by the detection portion.

Also in aspect 15, the variation in the jetting characteristic of the nozzle can be appropriately and easily evaluated.

In addition, there is provided a control method of a liquid jetting apparatus according to aspect 16, which is another preferred aspect, including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element, the control method including performing minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving, causing the detection portion to detect, as first residual vibration, the residual vibration caused by continuously performing the vibration driving, causing the detection portion to detect, as second residual vibration, the residual vibration caused by continuously driving the piezoelectric element in order of the minute vibration driving and the vibration driving, and determining a waveform of the minute vibration pulse based on the first residual vibration and the second residual vibration detected by the detection portion.

Also in aspect 16, the waveform of the minute vibration pulse for driving the piezoelectric element such that the liquid is not jetted from the nozzle can be appropriately and easily determined.

What is claimed is:

1. A liquid jetting apparatus comprising:
a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element; and
a control portion, wherein
the control portion
is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving,
causes the detection portion to detect, as first residual vibration, the residual vibration caused by continuously performing the vibration driving,
causes the detection portion to detect, as second residual vibration, the residual vibration caused by continuously driving the piezoelectric element in order of the minute vibration driving and the vibration driving, and
evaluates a variation in a jetting characteristic of the nozzle between a case where the vibration driving is continuous and a case where the vibration driving is not continuous based on the first residual vibration and the second residual vibration detected by the detection portion.

2. The liquid jetting apparatus according to claim 1, wherein
the control portion evaluates the variation in the jetting characteristic of the nozzle based on a phase of the first residual vibration and a phase of the second residual vibration.

3. The liquid jetting apparatus according to claim 2, wherein
the control portion determines that the jetting characteristic of the nozzle varies when the phase of the second residual vibration is not included in a range based on the phase of the first residual vibration.

4. The liquid jetting apparatus according to claim 1, wherein
the control portion evaluates the variation in the jetting characteristic of the nozzle based on an amplitude of the first residual vibration and an amplitude of the second residual vibration.

5. The liquid jetting apparatus according to claim 4, wherein
the control portion determines that the jetting characteristic of the nozzle varies when an amplitude of a first peak of the second residual vibration is not included in a first range based on an amplitude of a first peak of the first residual vibration.

6. The liquid jetting apparatus according to claim 5, wherein
the control portion determines that the jetting characteristic of the nozzle varies when an amplitude of a second peak of the second residual vibration is not included in a second range based on an amplitude of a second peak of the first residual vibration.

7. The liquid jetting apparatus according to claim 6, wherein
the first range is a range in which a value obtained by multiplying the amplitude of the first peak of the first residual vibration by a first coefficient is subtracted from or added to the amplitude of the first peak of the first residual vibration,
the second range is a range in which a value obtained by multiplying the amplitude of the second peak of the first residual vibration by a second coefficient is subtracted from or added to the amplitude of the second peak of the first residual vibration, and
the second coefficient is smaller than the first coefficient.

8. The liquid jetting apparatus according to claim 1, wherein
the control portion
evaluates the variation in the jetting characteristic of the nozzle with a first minute vibration pulse as the minute vibration pulse, and
further evaluates the variation in the jetting characteristic of the nozzle with a second minute vibration pulse having a pulse width different from a pulse width of the first minute vibration pulse as the minute vibration pulse.

9. The liquid jetting apparatus according to claim 1, wherein
the control portion
evaluates the variation in the jetting characteristic of the nozzle with a first minute vibration pulse as the minute vibration pulse, and
further evaluates the variation in the jetting characteristic of the nozzle with a second minute vibration pulse having an amplitude different from an amplitude of the first minute vibration pulse as the minute vibration pulse.

10. The liquid jetting apparatus according to claim 1, wherein
the control portion
performs the minute vibration driving by applying the minute vibration pulse to the piezoelectric element at a first timing within a unit period for driving the piezoelectric element and evaluates the variation in the jetting characteristic of the nozzle, and
further performs the minute vibration driving by applying the minute vibration pulse to the piezoelectric element at a second timing different from the first timing within the unit period and evaluates the variation in the jetting characteristic of the nozzle.

11. The liquid jetting apparatus according to claim 1, wherein
the control portion
evaluates the variation in the jetting characteristic of the nozzle with a first minute vibration pulse including at least one pulse as the minute vibration pulse, and
further evaluates the variation in the jetting characteristic of the nozzle with a second minute vibration pulse including the number of pulses different from the number of pulses included in the first minute vibration pulse as the minute vibration pulse.

12. The liquid jetting apparatus according to claim 1, wherein
the control portion
causes the detection portion to detect the residual vibration caused by continuously performing the vibration driving for three times as the first residual vibration,
causes the detection portion to detect, as the second residual vibration, the residual vibration caused by continuously driving the piezoelectric element in order of the minute vibration driving, the minute vibration driving, and the vibration driving,
causes the detection portion to detect, as third residual vibration, the residual vibration caused by continuously driving the piezoelectric element in order of the minute vibration driving, the vibration driving, and the vibration driving, and
evaluates the variation in the jetting characteristic of the nozzle based on the first residual vibration, the second residual vibration, and the third residual vibration detected by the detection portion.

13. The liquid jetting apparatus according to claim 1, wherein
the vibration pulse is a pulse for jetting the liquid from the nozzle.

14. A liquid jetting apparatus comprising:
a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element; and
a control portion, wherein
the control portion
is configured to perform minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving,
causes the detection portion to detect, as first residual vibration, the residual vibration caused by continuously performing the vibration driving,
causes the detection portion to detect, as second residual vibration, the residual vibration caused by continuously driving the piezoelectric element in order of the minute vibration driving and the vibration driving, and
determines a waveform of the minute vibration pulse based on the first residual vibration and the second residual vibration detected by the detection portion.

15. A control method of a liquid jetting apparatus including a liquid jetting head that includes a nozzle which jets a liquid, a piezoelectric element which corresponds to the nozzle, a vibration plate which vibrates by driving the piezoelectric element, and a detection portion which detects residual vibration of the vibration plate caused by driving of the piezoelectric element, the control method comprising:
performing minute vibration driving in which the piezoelectric element is driven with a minute vibration pulse for not jetting the liquid from the nozzle and vibration driving in which the piezoelectric element is driven with a vibration pulse for generating, at the vibration plate, vibration larger than vibration of the vibration plate caused by the minute vibration driving;
causing the detection portion to detect, as first residual vibration, the residual vibration caused by continuously performing the vibration driving;
causing the detection portion to detect, as second residual vibration, the residual vibration caused by continuously driving the piezoelectric element in order of the minute vibration driving and the vibration driving; and
evaluating a variation in a jetting characteristic of the nozzle between a case where the vibration driving is continuous and a case where the vibration driving is not continuous based on the first residual vibration and the second residual vibration detected by the detection portion.
